(19) United States
(12) Patent Application Publication
(10) Pub. No.: US 2026/0194843 A1
(43) Pub. Date: Jul. 9, 2026

(54) TRANSFER SHEET AND IMAGE FORMING METHOD

(71) Applicants: Kazumi Suzuki, Shizuoka (JP); Toyoshi Sawada, Shizuoka (JP); Katsunori Kurose, Shizuoka (JP)

(72) Inventors: Kazumi Suzuki, Shizuoka (JP); Toyoshi Sawada, Shizuoka (JP); Katsunori Kurose, Shizuoka (JP)

(73) Assignee: Etria Co., Ltd., Kanagawa (JP)

(21) Appl. No.: 19/441,980

(22) Filed: Jan. 7, 2026

(30) Foreign Application Priority Data
Jan. 9, 2025 (JP) 2025-003264

(51) Int. Cl. G03G 15/16; G03G 7/00; G03G 9/087; G03G 13/16

(52) U.S. Cl. CPC G03G 15/162; G03G 7/0093; G03G 9/08764; G03G 13/16

(57) ABSTRACT

A transfer sheet is provided that includes a release support, a first toner, and a second toner. The release support has a surface having a peeling force of 250 mN/25 mm or more and 2000 mN/25 mm or less. The first toner includes a release agent and a binder resin, and the binder resin includes a polyurethane resin accounting for 50% by mass or more of the first toner. The toner has a sea-island structure in a scanning electron microscopic image of a cross section of the first toner, and has a glass transition temperature of lower than 0° C. The second toner is a color toner including a binder resin, a colorant, and a release agent. The second toner is layered over the surface of the release support, and the first toner is layered over the second toner.

### CROSS-REFERENCE TO RELATED APPLICATIONS

This patent application is based on and claims priority pursuant to 35 U.S.C. § 119 (a) to Japanese Patent Application No. 2025-003264, filed on Jan. 9, 2025, in the Japan Patent Office, the entire disclosure of which is hereby incorporated by reference herein.

### BACKGROUND

### Technical Field

The present disclosure relates to a transfer sheet and an image forming method.

### Related Art

The electrophotographic method, in which a visible image is formed by developing an electrostatic latent image with a developer, involves forming an electrostatic latent image on an electrostatic latent image bearer (also called a photoconductor) including a photoconductive material, developing the electrostatic latent image with a developer including a toner to form a toner image, transferring the toner image to a transfer material such as paper, and then fixing the toner image by applying heat and pressure to form a fixed image.

To form a full-color image using the electrophotographic method, it is common to use a toner set that combines toners of three process colors (sometimes simply called process colors), cyan, magenta, and yellow, with a black toner.

In recent years, as electrophotographic color image forming apparatuses have become more widespread, the applications of printed materials have expanded to a wide variety of fields. Particularly in the field of custom-designed general consumer goods or the like, there is a growing need for electrophotographic printing on materials that cannot be printed (fixed) with conventional electrophotographic toners intended for printing on paper media. Specifically, there is a growing need for printing on fabric and leather media such as uniforms, shoes, and bags for sports teams.

Direct printing methods using inkjet printers or thermal transfer printers are effective when producing many items of the same shape or when producing large items. However, when the items to be printed are small (e.g., clothing) or when producing a wide variety of items with different shapes in small quantities, the method of transferring the items to be printed to the printer is different for each item, which makes production complex and time-consuming.

### SUMMARY

Embodiments of the present invention provides a transfer sheet that includes a release support, a first toner, and a second toner. The release support has a surface having a peeling force of 250 mN/25 mm or more and 2000 mN/25 mm or less. The first toner includes a release agent and a binder resin, and the binder resin includes a polyurethane resin accounting for 50% by mass or more of the first toner. The toner has a sea-island structure in a scanning electron microscopic image of a cross section of the first toner, and has a glass transition temperature of lower than 0° C. The second toner is a color toner including a binder resin, a colorant, and a release agent. The second toner is layered over the surface of the release support, and the first toner is layered over the second toner.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an image forming method in which an image is transferred to a transfer medium by thermal pressure transfer using a transfer sheet according to one embodiment of the present disclosure;

FIG. 2 is a schematic diagram illustrating a transfer sheet production apparatus for producing a transfer sheet according to one embodiment of the present disclosure;

FIG. 3 is a schematic diagram illustrating another transfer sheet production apparatus for producing a transfer sheet according to one embodiment of the present disclosure;

FIG. 4 is a schematic diagram illustrating yet another transfer sheet production apparatus for producing a transfer sheet according to one embodiment of the present disclosure;

FIG. 5 is a partially enlarged view of FIG. 4;

FIG. 6 is a schematic diagram illustrating a process cartridge according to one embodiment of the present disclosure; and

FIG. 7 is an average cross-sectional scanning electron microscopic (SEM) image of a toner component melt-kneaded coarsely pulverized product particle.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

According to the present disclosure, a transfer sheet that exhibits excellent image fixability and transferability and forms an image with a wide range of glossiness is provided.

### (Transfer Sheet)

A transfer sheet of the present disclosure includes a release support, a first toner, and a second toner, with the second toner layered over a surface of the release support and the first toner layered over the second toner.

### <First Toner>

The first toner includes a binder resin including a polyurethane resin, and a release agent, and may further include other components as needed, such as a colorant, a charge control agent, an external additive, a flowability improver, a cleaning improver, and a magnetic material.

The first toner is layered on the outermost surface of the transfer sheet of the present disclosure, and therefore functions as a base layer for a transfer image when transferred to a transfer medium. The materials for the first toner are described in more detail below.

### <<Binder Resin Including Polyurethane Resin>>

The binder resin of the first toner includes a polyurethane resin. The polyurethane resin generally has excellent tensile force (tensile strength), abrasion resistance, elasticity, and oil resistance. In terms of polyurethane resin composition, it is preferable to use a polyurethane resin including an aliphatic diol such as 1,4-butanediol and 1,6-hexanediol, adipic acid, diphenylmethane diisocyanate, and the like. Further, it is preferable for the polyurethane resin to have a glass transition temperature below 0° C. and a weight-average molecular weight in a range of 40,000 to 130,000. Using the polyurethane resin that meets these conditions can ensure the flexibility of the toner layer after fixing.

The specific trade name of the polyurethane resin is not particularly limited and can be appropriately selected depending on the purpose. Examples thereof include, but are not limited to, hot melt powder ECOFREEN POWDER (manufactured by Ecofreen Co., Ltd.), T8175N (manufactured by DIC Covestro Polymer Ltd.), and P22MBRNAT (manufactured by Nippon Miractran Co, Ltd.).

As a resin component other than the polyurethane resin, a conventionally known resin can be used.

Examples thereof include, but are not limited to, a styrene-based resin (a homopolymer or a copolymer including styrene or a styrene substitute) such as styrene, poly-α-methyl styrene, a styrene-chlorostyrene copolymer, a styrene-propylene copolymer, a styrene-butadiene copolymer, a styrene-vinyl chloride copolymer, a styrene-vinyl acetate copolymer, a styrene-maleic acid copolymer, a styrene-acrylic acid ester copolymer, a styrene-methacrylic acid ester copolymer, a styrene-α-methyl chloroacrylate copolymer, or a styrene-acrylonitrile-acrylic acid ester copolymer, an epoxy resin, a vinyl chloride resin, a rosin-modified maleic acid resin, a phenolic resin, a polyethylene resin, a polypropylene resin, a petroleum resin, a polyester resin, a ketone resin, an ethylene-ethyl acrylate copolymer, a xylene resin, and a polyvinyl butyrate resin. Further, a production method for these resins is not particularly limited, and the method such as bulk polymerization, solution polymerization, emulsion polymerization, or suspension polymerization can be used.

Of these resins, the polyester resin is preferably included because it allows low-temperature fixation while maintaining heat-resistant storage stability compared to other resins. Further, the polyurethane resin is preferably used in combination with the polyester resin since a sea-island structure can be formed in an incompatible state when the polyester resin and the polyurethane resin are used in combination.

The polyester resin used in the present disclosure is preferably obtained by condensation polymerization of an alcohol and a carboxylic acid. The alcohol to be used is not particularly limited and can be appropriately selected depending on the purpose, and examples thereof include, but are not limited to, a glycol such as ethylene glycol, diene glycol, triethylene glycol, or propylene glycol, an etherified bisphenol such as 1,4-bis(hydroxymeta)cyclohexane or bisphenol A, a dihydric alcohol monomer, and a trihydric or higher polyhydric alcohol monomer.

Further, the carboxylic acid is not particularly limited and can be appropriately selected depending on the purpose. Examples thereof include a divalent organic acid monomer such as maleic acid, fumaric acid, phthalic acid, isophthalic acid, terephthalic acid, succinic acid, or malonic acid, and a trivalent or higher polyvalent carboxylic acid monomer such as 1,2,4-benzenetricarboxylic acid, 1,2,5-benzenetricarboxylic acid, 1,2,4-cyclohexanetricarboxylic acid, 1,2,4-naphthalenetricarboxylic acid, 1,2,5-hexanetricarboxylic acid, 1,3-dicarboxyl-2-methylenecarboxypropane, or 1,2,7,8-octanetetracarboxylic acid.

Further, it is preferable that the softening temperature and the glass transition temperature of the polyester resin are both 60° C. or higher. If the softening temperature and the glass transition temperature of the polyester resin are both 60° C. or higher, the heat-resistant storage stability of the toner image can be ensured.

The weight-average molecular weight of the polyurethane resin is preferably 40,000 to 130,000, more preferably 40,000 to 110,000, even more preferably 40,000 to 100,000. When the weight-average molecular weight is 40,000 or more, there is no risk of the fixed image melting when ironed, and when the weight-average molecular weight is 130,000 or less, it becomes easy to perform melting and kneading with other toner components and an adhesive when producing a toner.

The polyurethane resin content is 50% by mass or more relative to the entire first toner, i.e., the polyurethane resin accounts for 50% by mass or more of the first toner, thereby forming a sea-island structure in which the polyurethane resin component forms a sea region and resin components other than the polyurethane resin form island regions in the cross section of the toner. By having the polyurethane resin content of 50% by mass or more relative to the entire first toner, sufficient fixability of the toner to a flexible medium such as a fabric and flexibility of the toner layer after fixation can be obtained. The polyurethane resin content is preferably 50% by mass or more and 80% by mass or less relative to the entire first toner. When the content is 80% by mass or less, the thermal storage stability of the toner is not deteriorated and there is no risk of aggregation of toner particles.

### <<Release Agent>>

In the first toner, the type of release agent (wax) that can be used is not particularly limited and can be appropriately selected depending on the purpose. Examples thereof include, but are not limited to, liquid paraffin, microcrystalline wax, natural paraffin, synthetic paraffin, polyolefin wax, and their partial oxides, an aliphatic hydrocarbon such as a fluoride or a chloride, an animal oil such as beef tallow or a fish oil, a vegetable oil such as a coconut oil, a soybean oil, a rapeseed oil, rice bran wax, or carnauba wax, a higher aliphatic alcohol and higher fatty acid such as montan wax, a fatty acid amide, a fatty acid bisamide, a metal soap such as zinc stearate, calcium stearate, magnesium stearate, aluminum stearate, zinc oleate, zinc palmitate, magnesium palmitate, zinc myristate, zinc laurate, or zinc behenate, a fatty acid ester, and polyvinylidene fluoride. Of these, it is preferable to include at least ester wax such as a fatty acid ester. These may be used alone or in combination of two or more types.

When the toner includes a maleic acid-modified polyolefin with a polypropylene block in its main chain, when the content thereof is high, the toner cannot be separated from a fixing roller (or fixing belt) during fixing, causing ejection paper jams. However, this problem can be prevented by adding ester wax as a release agent. Further, the maleic acid-modified polyolefin with a polypropylene block in its main chain can finely disperse the ester wax.

The content of the release agent in the toner is not particularly limited and can be selected appropriately depending on the purpose. However, the content is preferably 0.1 to 8.0% by mass, more preferably 1.0 to 6.0% by mass. When the content is 0.1% by mass or more, the toner and the fixing roller (or fixing belt) separate during fixing, preventing ejection paper jams. Further, when the content is 8.0% by mass or less, the toner can be sufficiently fixed to a plastic film.

### <<Colorant>>

The first toner may optionally include a white pigment as a colorant to form a white image that conceals the color of the transfer medium. By concealing the color of the transfer medium, the color of the transfer image is reproduced vividly without being affected by the color of the transfer medium.

The white pigment used in the present disclosure is not particularly limited and can be appropriately selected depending on the purpose. Examples thereof that can be used include, but are not limited to, titanium dioxide, white lead, talc, kaolin, zinc sulfide, barium sulfate, calcium carbonate, zinc oxide, and hollow silica.

Further, the surface of the white pigment can be treated with silicon, zirconia, aluminum, an organic substance such as a polyol, or the like. Preferably, titanium dioxide is surface-treated with aluminum and an organic substance such as a polyol. It is presumed that the surface treatment allows the release agent in the toner to be wetted by the white pigment, thereby softening the hardness of the toner layer and producing a white concealing layer less susceptible to cracking.

The optimum white pigment content varies depending on the pigment type, but is preferably 20% by mass or more and 50% by mass or less, more preferably 30% by mass or more and 40% by mass or less. When the white pigment content is 20% by mass or less, the concealing property decreases, causing the design of the transfer medium to show through and lowering the saturation and brightness of the image. On the other hand, when the white pigment content is 50% by mass or more, flexibility cannot be ensured, and cracks may occur in the toner layer formed on the flexible transfer medium.

### <<Charge Control Agent>>

The first toner may include a charge control agent.

The charge control agent can be selected appropriately depending on the purpose as long as it is white or colorless. Examples thereof include an onium salt such as a phosphonium salt and a lake pigment thereof, a triphenylmethane dye and a lake pigment thereof, a metal salt of a higher fatty acid, a diorganotin oxide such as dibutyltin oxide, dioctyltin oxide, or dicyclohexyltin oxide, a diorganotinborate such as dibutyltin borate, dioctyltin borate, or dicyclohexyltin borate, an organometallic complex, a chelate compound, a monoazometal complex, an acetylacetonemetal complex, an aromatic hydroxycarboxylic acid, a metal complex of an aromatic dicarboxylic acid, and a quaternary ammonium salt. Other examples include an aromatic hydroxycarboxylic acid, an aromatic mono- or poly-carboxylic acid and a metal salt, an anhydride, and an ester thereof, and a phenol derivative such as bisphenol. These can be used alone or in combination of two or more types.

When these charge control agents are added internally to the toner for electrophotographic development, the content is not particularly limited and can be appropriately set depending on the purpose. However, it is preferable to add them in an amount of 0.1% to 10% by mass relative to the total amount of the binder resin.

### <<External Additive>>

The first toner may include inorganic fine particles or the like as an external additive.

The inorganic fine particles to be added externally in the present disclosure are not particularly limited and can be selected appropriately depending on the purpose. Examples thereof include, but are not limited to, silica, alumina, titanium oxide, barium titanate, magnesium titanate, calcium titanate, strontium titanate, zinc oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. Of these, silica, alumina, and titanium oxide are preferable.

Further, the inorganic fine particles in use may be surface-treated with a hydrophobic treatment agent. The hydrophobic treatment agent is not particularly limited and can be appropriately selected depending on the purpose. Preferable examples thereof include, but are not limited to, a silane coupling agent, a silylating agent, a silane coupling agent with a fluorinated alkyl group, an organic titanate coupling agent, and an aluminum coupling agent. Further, sufficient effects can be obtained by using silicone oil as the hydrophobic treatment agent.

Further, the average particle diameter of the primary particles of the inorganic fine particles is not particularly limited and can be selected appropriately depending on the purpose. However, the average particle diameter is preferably 5 to 500 nm, more preferably 5 to 200 nm. When it is 5 nm or more, aggregation of the inorganic fine particles can be prevented, and the inorganic fine particles can be uniformly dispersed in the toner. When it is 500 nm or less, the heat-resistant storage stability can be improved due to the filler effect. The average particle diameter described herein is a value obtained by directly determining the particle diameter from a photograph obtained by a transmission electron microscope, and it is preferable to observe at least 100 or more particles and use the average value of the major axes.

### <<Flowability Improver>>

The first toner may include a flowability improver as an additive. The flowability improver is not particularly limited and can be appropriately selected depending on the purpose, as long as the surface treatment with the flowability improver can increase hydrophobicity and prevent deterioration in flow properties and charging properties under high humidity. Examples thereof include, but are not limited to, a silane coupling agent, a silylating agent, a silane coupling agent with a fluorinated alkyl group, an organic titanate coupling agent, an aluminum coupling agent, a silicone oil, and a modified silicone oil.

The silica and titanium oxide used as the external additives are preferably surface-treated with such a flowability improver and used as hydrophobic silica and hydrophobic titanium oxide.

### <<Cleaning Improver>>

The first toner may include a cleaning improver as an additive. The cleaning improver is not particularly limited and can be appropriately selected depending on the purpose, as long as it can be added to the first toner for the ease of removal of residual developer remaining on the photoconductor or a primary transfer medium after transfer. Examples thereof include, but are not limited to, a fatty acid metal salt such as zinc stearate, calcium stearate, or stearic acid, and polymer fine particles produced by soap-free emulsion polymerization, such as polymethyl methacrylate fine particles or polystyrene fine particles. The polymer fine particles preferably have a relatively narrow particle size distribution, with a volume average particle diameter preferably in a range of 0.01 μm or more and 1 μm or less.

### <<Incompatible Domain Observation>>

The size and shape of domains in the toner can be confirmed by observing a backscattered electron image with a scanning electron microscope (SEM). The presence of sea regions and island regions (incompatible domains) can be confirmed by the color difference between the island regions (domains) and the sea regions (matrix) in the sea-island structure of the toner. To enhance contrast and facilitate identification of the island regions and sea regions, ruthenium tetroxide staining may be performed, if necessary. Further, in order to facilitate cutting, the specimen may be cut in a frozen state.

The following procedure and conditions can be mentioned as an example of backscattered electron image observation using the scanning electron microscope.

The sea-island structure of the present disclosure can be observed in the same manner in both the toner particles and the toner component melt-kneaded coarsely pulverized product.

The toner particles or the particles of the toner component melt-kneaded coarsely pulverized product are embedded in an epoxy resin, frozen, and cross-sectioned. Then, observation can be performed using a scanning electron microscope (manufactured by Hitachi, Ltd., SU8-230) under the following conditions. In this case, the unstained regions are observed as dark regions, making them distinguishable from the stained regions (light regions).
Acceleration voltage: 5 kV
Emission current: 10 μA
Probe current: Normal
Condenser lens: 1:5.0.
W.D.: 8.0 mm
Observation mode: SE
Magnification: ×2,000 or ×5,000

### <<Method for Measuring Toner Average Particle Diameter and Particle Diameter Distribution>>

The particle diameter distribution and particle diameter of the toner based on a volume percentage can be measured, for example, using a laser diffraction particle size distribution analyzer (“SALD-2300”, manufactured by Shimadzu Corp.). An example of the measurement is described below.

First, 0.5 ml of 10% by mass surfactant (alkylbenzene sulfonate, NEOGEN SC-A, manufactured by DKS Co. Ltd.) is added to a 100 ml glass beaker, 2 to 4 g of each toner is added, and the mixture is stirred with a microspatula. Then, 80 ml of ion-exchanged water is added to obtain a dispersion liquid. The resulting dispersion liquid is dispersed for 10 minutes in an ultrasonic disperser (W-113MK-II, manufactured by Honda Electronics Co., LTD.) to obtain a toner sample dispersion liquid. The toner sample dispersion liquid is then measured using the SALD-2300.

### <<Average Toner Particle Diameter>

The average particle diameter of the first toner is not particularly limited and can be selected appropriately depending on the purpose. However, the average particle diameter is preferably 10 to 50 μm, more preferably 10 to 30 μm. With the toner described above, increasing the toner particle diameter increases the pile height of the toner layer, thereby facilitating the filling of surface irregularities on a flexible medium such as a fabric and resulting in excellent concealing properties, which is therefore preferable. Further, in view of balancing with transferability, which is in trade-off with the concealing properties, the average particle diameter is preferably 50 μm or less, more preferably 30 μm or less.

### <<Confirmation and Quantification of Resin in Toner>>

For the resin included in the first toner, its presence and quantification can be suitably determined by gas chromatography-mass spectrometry (GC-MS) or nuclear magnetic resonance (NMR). Specifically, the quantification can be carried out using the following procedures, instruments, and conditions.

### <<Compositional Analysis by GC-MS>>

### —Sample Preparation—

The toner is dispersed in chloroform and stirred overnight to obtain a dispersion liquid. Subsequently, this dispersion liquid is centrifuged, and only the supernatant is collected. The collected supernatant is evaporated to dryness and subjected to compositional analysis by gas chromatography-mass spectrometry (GC-MS). An example of measurement conditions for GC-MS is described below. Note that a sample is a mixture prepared by dropping about 1 μL of a methylating agent (20% methanol solution of tetramethylammonium hydroxide: TMAH) onto about 1 mg of the specimen.

### —Measurement Conditions—

Pyrolysis-gas chromatography mass spectrometer (Py-GCMS) analyzer: QP2010 (manufactured by Shimadzu Corp.)
Heating furnace: Py2020D (manufactured by Frontier Laboratories Ltd.)
Heating temperature: 320° C.
Column: Ultra ALLOY-5 (L=30 m, I.D=0.25 mm, Film=0.25 μm, manufactured by GL Sciences Inc.)
Column temperature: 50° C. (hold time: 1 min−heating (10° C./min)−340° C. (hold time: 7 min)
Split ratio: 1:100
Column flow rate: 1.0 ml/min
Ionization method: EI method (70 eV)
Measurement mode: scan mode
Search data: NIST 20 Mass Spectral Library

### <<Compositional Analysis by NMR>>

### —Sample Preparation—

The toner is dispersed in chloroform and stirred overnight to obtain a dispersion liquid. This dispersion liquid is then centrifuged, and only the supernatant is collected. The collected supernatant is evaporated to dryness and used as a sample for ¹H-NMR and ¹³C-NMR by subjecting it to compositional analysis by NMR. An example of the sample preparation method for ¹H-NMR, the sample preparation method for ¹³C-NMR, and the measurement conditions is described below.

### (1) Sample Preparation Method for ¹H-NMR

A ¹H-NMR sample is prepared by adding 1 mL of d₈-toluene (manufactured by FUJIFILM Wako Pure Chemical Corp.) to 100 mg of the specimen, followed by heating with a dryer to dissolve the specimen.

### (2) Sample Preparation Method for ¹³C-NMR

A ¹³C-NMR sample is prepared by adding 1 mL of deuterated 1,2-dichlorotoluene (manufactured by FUJIFILM Wako Pure Chemical Corp.) to 100 mg of the specimen, followed by heating with a dryer to dissolve the specimen.

### —Measurement Conditions—

NMR instrument: ECX-500 (manufactured by JEOL Ltd.)
Measurement nucleus=¹H (500 MHz), measurement pulse file=single pulse dec.jxp (¹H), 45° C. pulse, 20,000 times scans, relaxation delay 4 seconds, data points 32K, offset 100 ppm, observation width=250 ppm, measurement temperature 70° C.
Measurement nucleus=¹³C (125 MHz), measurement pulse file=single pulse dec.jxp (¹³C), 45° C. pulse, 64 times scans, relaxation delay 5 seconds, data points 32K, observation width=15 ppm, measurement temperature 65° C.

### <<Weight-Average Molecular Weight Measurement>>

The weight-average molecular weight of the resin used in the toner can be obtained by measuring the molecular weight distribution of the tetrahydrofuran (THF) soluble fraction using a gel permeation chromatography (GPC) analyzer. The GPC analyzer is not particularly limited and can be appropriately selected depending on the purpose. For example, by trade name, GPC-150C (manufactured by Waters Corp.) or the like can be used.

The column used for measuring the weight-average molecular weight is not particularly limited and can be appropriately selected depending on the purpose. Examples thereof include, but are not limited to, by trade name, KF801 (organic solvent SEC (GPC) column), KF802 (organic solvent SEC (GPC) column), KF803 (organic solvent SEC (GPC) column), KF804 (organic solvent SEC (GPC) column), KF805 (organic solvent SEC (GPC) column), KF806 (organic solvent SEC (GPC) column), and KF807 (organic solvent SEC (GPC) column) (all manufactured by Showa Denko K.K.).

A method for measuring the weight average molecular weight of the resin used in the toner is not particularly limited and can be appropriately selected depending on the purpose. For example, the measurement can be performed by the following method.

The column is stabilized in a heat chamber at 40° C., and THF is passed through the column at a flow rate of 1 mL/min as a solvent. Next, 0.05 g of the specimen is thoroughly dissolved in 5 g of THF and then filtered through a pretreatment filter (e.g., trade name: Chromatodisc, pore size: 0.45 μm, manufactured by Kurabo Industries Ltd.). The final specimen concentration is adjusted to 0.05% by mass to 0.6% by mass. A THF sample solution with the adjusted specimen concentration is injected into the column in an amount of 50 μL to 200 μL. After separating the THF-soluble fraction included in the THE sample solution, the weight average molecular weight (Mw) of the THF-soluble fraction included in the THE sample solution can be measured by converting the signal to molecular weight using a detector (e.g., a refractive index (RI) detector (instrument name: GPC-150C, manufactured by Waters Corp.)).

For the measurement of the weight average molecular weight Mw and the number average molecular weight Mn of the THF-soluble fraction included in the sample, the molecular weight distribution of the sample is calculated based on the relationship between the logarithmic values of a calibration curve created using several monodisperse polystyrene standard samples, and the count numbers.

As the standard polystyrene samples for creating the calibration curve, for example, the ones with the molecular weight of 6×10², 2.1×10³, 4×10³, 1.75×10⁴, 5.1×10⁴, 1.1×10⁵, 3.9×10⁵, 8.6×10⁵, 2×10⁶, and 4.48×10⁶ manufactured by Pressure Chemical Co. or Tohso Corp. are used. It is preferable to use at least about 10 different standard polystyrene samples. Further, it is also preferable to use a refractive index (RI) detector as the detector.

### <<Softening Temperature Measurement Method>>

The softening temperature can be measured using a flow tester (manufactured by Shimadzu Corp., CFT-500D). Specifically, by means of the flow tester, 1.0 g of the specimen is heated at a temperature rise rate of 6° C./min while applying a load of 1.96 MPa with a plunger, and extruded through a nozzle having a diameter of 1.0 mm and a length of 1.0 mm. The plunger displacement of the flow tester with respect to temperature is plotted, and the temperature at which deformation of the specimen first occurs (i.e., the temperature at which the specimen begins to deform as it changes from a solid state to a rubbery state) can be determined as the softening temperature.

### <<Glass Transition Temperature Tg>>

The glass transition temperature Tg of the first toner is lower than 0° C., preferably-30° C. or higher and −10° C. or lower.

### <Method for Measuring Glass Transition Temperature Tg>>

The glass transition temperature Tg can be measured using, for example, a differential scanning calorimeter (manufactured by Seiko Instruments Inc., DSC210). Specifically, 0.01 to 0.02 g of the specimen is weighed into an aluminum pan at room temperature using the differential scanning calorimeter, and cooled to −20° C. at a temperature decrease rate of 10° C./min. The specimen is then heated to 200° C. at a temperature rise rate of 10° C./min, and Tg can be determined as the temperature at the intersection of the extended baseline and the tangent indicating the maximum slope from the onset of the peak rise to the peak apex.

### <Second Toner>

The second toner includes a binder resin, a colorant, and a release agent, and may further optionally include other components such as a charge control agent, an external additive, a flowability improver, a cleaning improver, and a magnetic material.

The second toner is a toner including a colorant, and functions as a color toner that forms a color image in the transfer sheet of the present disclosure. The materials for the second toner are described in more detail below. Note that the binder resin and components other than the colorant in the second toner can be the same as those in the first toner, thus a description thereof is omitted. The toner analysis method can also be performed in the same manner as the first toner, thus a description thereof is also omitted.

### <<Binder Resin>>

The binder resin used as the second toner material can be any conventionally known resins. Examples thereof include, but are not limited to, a styrene-based resin (a homopolymer or a copolymer including styrene or a styrene substitute) such as styrene, poly-α-methyl styrene, a styrene-chlorostyrene copolymer, a styrene-propylene copolymer, a styrene-butadiene copolymer, a styrene-vinyl chloride copolymer, a styrene-vinyl acetate copolymer, a styrene-maleic acid copolymer, a styrene-acrylic acid ester copolymer, a styrene-methacrylic acid ester copolymer, a styrene-α-methyl chloroacrylate copolymer, or a styrene-acrylonitrile-acrylic acid ester copolymer, an epoxy resin, a vinyl chloride resin, a rosin-modified maleic acid resin, a phenolic resin, a polyethylene resin, a polypropylene resin, a petroleum resin, a polyurethane resin, a polyester resin, a ketone resin, an ethylene-ethyl acrylate copolymer, a xylene resin, and a polyvinyl butyrate resin. Further, a production method for these resins is not particularly limited, and the method such as bulk polymerization, solution polymerization, emulsion polymerization, or suspension polymerization can be used.

The resin used in the second toner preferably includes the polyester resin. When the second toner includes the polyester resin, the adhesion between the second toner and the first toner is improved, resulting in a printed matter with higher durability.

Further, from the standpoint of achieving higher adhesion to and improved durability with the layer formed by the first toner, it is preferable that the resin used in the second toner includes the same polyester resin as that used in the first toner.

It is preferable that the second toner includes the polyurethane resin as the binder resin. By including the polyurethane resin in the second toner, a highly durable image layer can be obtained in which cracking and peeling are less likely to occur.

Further, from the standpoint of achieving higher adhesion to and improved durability with the layer formed by the first toner, it is preferable that the resin used in the second toner includes the same polyurethane resin as that used in the first toner.

### <<Colorant>>

The second toner is not particularly limited and can employ any commonly used colorant selected appropriately. Examples thereof include, but are not limited to, a black toner, a cyan toner, a magenta toner, a yellow toner, a red toner, a green toner, a blue toner, a fluorescent pink toner, a fluorescent blue toner, and a fluorescent yellow toner.

The black toner is not particularly limited, and any colorant can be selected appropriately depending on the purpose. However, it is preferable to use carbon black alone, or a mixture in which carbon black as the main component is combined with copper phthalocyanine or the like to adjust hue and brightness.

The cyan toner is not particularly limited, and any colorant can be selected appropriately depending on the purpose. However, it is preferable to use copper phthalocyanine, which is Pigment Blue 15:3, or a mixture of the above-mentioned colorant and aluminum phthalocyanine.

The magenta toner is not particularly limited, and any colorant can be selected appropriately depending on the purpose. However, Pigment Red 53:1, Pigment Red 81, Pigment Red 122, and Pigment Red 269 can be used either individually or in combination.

The yellow toner is not particularly limited, and any colorant can be selected appropriately depending on the purpose. However, Pigment Yellow 74, Pigment Yellow 155, Pigment Yellow 180, and Pigment Yellow 185 can be used either individually or in combination. From the standpoint of saturation and storage stability, it is preferable to use Pigment Yellow 185 alone, or a mixture of Pigment Yellow 185 and Pigment Yellow 74.

The red toner is not particularly limited, and any colorant can be selected appropriately depending on the purpose. However, Pigment Red 254, Pigment Red 166, Pigment Red 144, and Pigment Red 48:2 can be used either individually or in combination.

The green toner is not particularly limited, and any colorant can be selected appropriately depending on the purpose. For example, Pigment Green 7 or the like can be used, but safety precautions need to be taken.

The blue toner is not particularly limited, and any colorant can be selected appropriately depending on the purpose. Examples thereof include, but are not limited to, Pigment Blue 15:1 and Pigment Violet 23.

### <Developer>

The toner used in the transfer sheet of the present disclosure can also be mixed with a carrier or the like and used as a developer. In other words, the developer includes the first toner or the second toner and, as necessary, may include other appropriately selected components such as a carrier. By using such a developer, a foundation layer having excellent fixability can be formed on the fabric surface.

The developer may be a one-component developer or a two-component developer. However, when used in a high-speed printer or the like that accommodates recent advances in information processing speed, it is preferable to use a two-component developer because it offers better longevity.

When the first toner or the second toner is used as a one-component developer, even after repeated toner replenishment, there is little variation in the particle diameter of the toner, there is little toner filming on the developing roller, and there is little toner fusion to members such as a blade that forms the thin toner layer, making it possible to obtain good and stable developability and images even during long-term agitation in the developing device.

The first toner or the second toner can be mixed with a carrier to form a two-component developer, which can be used in an electrophotographic image forming method employing a two-component developing system. When the first toner or the second toner is used as the two-component developer, even after repeated toner replenishment for a long period of time, there is little variation in the particle diameter of the toner, making it possible to obtain good and stable developability and images even during long-term agitation in the developing device.

When using the two-component developing system, the magnetic fine particles used in the magnetic carrier are not particularly limited and can be appropriately selected depending on the purpose. Examples thereof include, but are not limited to, iron powder, a spinel ferrite such as magnetite or γ-iron oxide, a spinel ferrite including one or more metals other than iron (Mn, Ni, Zn, Mg, Cu, etc.), a magnetoplumbite-type ferrite such as barium ferrite, and particles of iron or an alloy having an oxide layer on its surface. Of these, white particles are preferable in terms of color tone.

The shape of the magnetic particles may be any of granular, spherical, and needle-like shape. In particular, when high magnetization is required for the magnetic carrier, it is preferable to use ferromagnetic fine particles such as iron fine particles.

Further, in view of chemical stability, it is preferable to use a spinel ferrite such as magnetite or γ-iron oxide, or a magnetoplumbite-type ferrite such as barium ferrite. Specifically, MFL-35S and MFL-35HS (manufactured by Powdertech), DFC-400M, DFC-410M, and SM-350NV (manufactured by Dowa Ip Creation Co., Ltd.), and the like are preferable.

It is possible to use a resin carrier having a desired magnetization by selecting the type and content of the ferromagnetic fine particles (carrier). For example, the magnetic properties of the resin carrier preferably exhibit a magnetization of 30 to 150 emu/g at 1,000 oersteds.

Such a resin carrier can be produced by spraying, with a spray dryer, a melt-kneaded product of magnetic fine particles and an insulating binder resin. Alternatively, by reacting and curing a monomer or prepolymer in an aqueous medium in the presence of magnetic fine particles, it is possible to produce a resin carrier in which the magnetic fine particles (carrier) are dispersed in a condensation-type binder.

The charging properties of the magnetic carrier can be controlled by fixing positively or negatively chargeable fine particles or conductive fine particles to its surface, or by coating the surface with a resin.

As a surface coating material (resin), a silicone resin, an acrylic resin, an epoxy resin, a fluororesin, or the like can be used. Further, the coating can include positively or negatively chargeable fine particles or conductive fine particles. Of these, a silicone resin and an acrylic resin are preferable.

In the present disclosure, the mass ratio of the carrier in the developer accommodated in the developing device is preferably 85% by mass or more and less than 98% by mass. When the mass ratio of the carrier in the developer is 85% by mass or more, scattering of the toner from the developing device is less likely to occur, thereby reducing the occurrence of defective images. When the mass ratio of the carrier in the developer is less than 98% by mass, excessive increase in the charge amount of the electrophotographic toner, insufficiency in the supply amount of the electrophotographic toner, and the like can be prevented, thereby reducing the occurrence of defective images due to a decrease in image density.

The volume-average particle diameter of the magnetic carrier is preferably 50 μm or more and 80 μm or less. In the image forming method of the present disclosure, it is preferable to perform developing with a larger toner in a single pass. When the volume-average particle diameter of the magnetic carrier is less than 50 μm, carrier adhesion is likely to occur, in which the magnetic carrier is developed together with the toner. When the volume-average particle diameter is 80 μm or more, the surface area of the magnetic carrier becomes small, making it difficult to retain a sufficient amount of toner on the magnetic carrier surface, which tends to result in a reduced amount of development, toner scattering, and background staining.

### <Release Support>

The release support used in the transfer sheet of the present disclosure refers to a sheet-like substrate having releasability, from which a toner layer printed thereon can be transferred to a transfer medium by heat and pressure.

The release support in the present disclosure is a support in which at least a release layer is provided on the substrate of paper or a heat-resistant plastic film sheet, with the outermost surface being the release layer.

The peeling force of the surface of the release support is preferably 250 mN/25 mm or more and 2000 mN/25 mm or less, more preferably 250 mN/25 mm or more and less than 500 mN/25 mm, or 1000 mN/25 mm or more and 2000 mN/25 mm or less. When the peeling force is less than 250 mN/25 mm, the toner does not fix on the release layer, causing offset and making image formation difficult. A peeling force of 250 mN/25 mm or more provides stable image fixability. When the peeling force is 2000 mN/25 mm or less, stable transferability to the transfer medium can be obtained. When the peeling force exceeds 2000 mN/25 mm, some parts of the image fail to be transferred because they are not separated from the transfer sheet during thermal transfer from the transfer sheet to the transfer medium. In particular, when transfer and releasing are carried out by cold peel, releasing defects frequently occur.

In the present disclosure, the peeling force is measured by the 31B tape method.

### [31B Tape Method]

An acrylic adhesive tape “31B #25” manufactured by Nitto Denko Corp. is applied to the release-treated surface using a 2-kg roller, and the peeling force after 30 minutes is measured (tape peel, peeling angle: 180°, peeling speed: 0.3 m/min).

The substrate is selected from paper, a film, and the like. From the viewpoints of heat resistance, substrate deformation, and carbon neutrality, the substrate is preferably paper.

As the paper, glassine paper, a high-quality paper, a kraft paper, and the like are used. However, depending on adhesion with the release agent, a barrier layer may be formed between the release layer and the substrate. Since the barrier layer is often formed from a heat-sensitive material such as polyethylene or polyvinyl alcohol, glassine paper, which does not require the barrier layer and allows the release layer to be formed directly on the substrate, is preferable. Glassine paper is also preferably used because its excellent light transmittance facilitates image alignment with the transfer medium.

When the substrate is paper, a basis weight is preferably 70 g/m² or more and 200 g/m² or less, more preferably 150 g/m² or less. The basis weight of 70 g/m² or more reduces the likelihood of paper jams during image formation. The basis weight is preferably 85 g/m² or more. When the basis weight is 200 g/m² or less, stable fixing conditions can be ensured. However, if it exceeds 200 g/m², the fixing conditions become severe, the temperature range allowing fixation becomes narrow, and both cold offset and hot offset are more likely to occur.

As the release agent used in the release layer, a silicone-based release agent and a non-silicone release agent can be mentioned. A silicone-based release agent is commonly used in an adhesive product and the like, and a wide variety are known, ranging from light release to heavy release. A non-silicone release agent is mainly used in applications such as an electronic device, where silicone may have adverse effects. The release agent of the release support used in the present disclosure may be either silicone-based or non-silicone-based, and is not limited to either.

Conventionally, a dedicated transfer sheet has been used in which a transfer layer including at least a thermoplastic elastomer and a higher fatty acid is formed on a substrate of paper or a heat-resistant plastic film sheet. By forming the thermoplastic elastomer release layer of the dedicated transfer sheet as the outermost image layer, the durability of the image on the transfer material is improved. Further, by including a higher fatty acid, the higher fatty acid melts during thermal transfer and diffuses into the simultaneously formed color toner layer and transfer material adhesion toner layer, thereby further improving the flexibility of the layers.

However, in the conventional dedicated transfer sheets, the release layer causes adverse effects under varying thermal transfer conditions, such as leaving transfer residues in non-image areas. Further, since some release layer is transferred together with the toner layer, reuse is difficult, resulting in high environmental impact as well as increased cost.

In the transfer sheet of the present disclosure, since the first toner includes 50% by mass or more of the polyurethane resin, sufficient image durability can be obtained even without the release layer that is transferred together with the toner layer. Further, because the release layer is not transferred together with the toner layer, the effects of variations in thermal transfer temperature and pressure are reduced, thereby achieving stable printability.

The color image formed on the release support is a mirror image of the original image, inverted left and right.

After being thermally transferred and printed onto the transfer medium, the image is again inverted left and right, forming the desired image on the transfer medium.

The mirror image inverted left to right can be formed by printing, with the image forming apparatus, mirror image information that has been previously inverted left to right using a PC or the like. In the case of the image forming apparatus equipped with a scanner function, the original image may be scanned, and then an inverted image may be output, or a mirror image that has been already inverted left to right may be scanned.

### (Toner Production Method)

A method for producing the first toner and the second toner used in the transfer sheet of the present disclosure is not particularly limited and can be selected appropriately depending on the purpose. An example of the toner production method is described below.

As the method for producing the first toner and the second toner, a melt-kneading pulverization method is preferable. This is because an inorganic pigment such as a white pigment has a greater specific gravity compared to other toner constituent materials, making granulation by a chemical method such as a dissolution-suspension method difficult, and because, for forming domains, a step of cooling and rolling the toner component melt-kneaded product is required.

In contrast, the chemical method such as the dissolution-suspension method can be employed in the present disclosure, provided that the chemical method adopts a toner material composition and step capable of internally dispersing an inorganic pigment such as a white pigment, and forming domains. The shape and size of the domains are determined by the compatibility between the domain material and the matrix material (which depends on the molecular weight and composition of each material) and by the rolling force applied during the cooling and rolling of the melt-kneaded product. Accordingly, the easiest method for controlling domain diameter and shape is to adopt mutually incompatible materials and, after previously determining the relationship between the size and shape of domains and rolling thickness, to reduce the thickness of the toner material melt-kneaded product to an appropriate thickness (preferably adjusted to 1 mm or less), thereby obtaining suitable domains.

The method for producing the first toner and the second toner can include a step of obtaining a mixture of the binder resin (mixing step), a step of obtaining a kneaded product of the mixture (melt-kneading step), a step of obtaining a solid product of the kneaded product (solidification step), a step of obtaining a pulverized product of the solid product (fine pulverization step), and a step of classifying and recovering the pulverized product (classification step).

### —Step of Obtaining Mixture of Binder Resin (Mixing Step)—

First, the binder resin and the release agent, and as necessary, the colorant, the charge control agent, and the like are mixed with a mixer to obtain a mixture (mixing step). The mixer is not particularly limited and can be appropriately selected depending on the purpose. Examples thereof include, but are not limited to, a Henschel mixer (trade name: FM20B, manufactured by Nippon Coke & Engineering. Co., Ltd.) and a super mixer (SMV-20Ba, manufactured by Kawata Mfg. Co., Ltd).

### —Step of Obtaining Kneaded Product of Mixture (Melt-Kneading Step)—

Next, the obtained mixture is melt-kneaded using a thermal melt-kneading machine to obtain a kneaded product (melt-kneading step). The thermal melt-kneading machine is not particularly limited and can be appropriately selected depending on the purpose. Examples thereof include, but are not limited to, by trade name, the twin-screw extruder PCM series (manufactured by Ikegai Co., Ltd.), the TEM extruder (manufactured by Shibaura Machine Co., Ltd.), the twin-screw extruder PCM Kneader (manufactured by Buss AG), and the open-roll type continuous kneader KNEADEX (manufactured by Nippon Coke & Engineering. Co., Ltd.).

### —Step of Obtaining Solid Product of Kneaded Product (Solidification Step)—

Next, the obtained kneaded product is cooled and solidified to obtain a solid product (solidification step). A cooling method and a solidification method are not particularly limited and can be appropriately selected depending on the purpose. For example, any suitable method can be employed.

However, in order to efficiently perform fine pulverization in the subsequent fine pulverization step, it is preferable in the solidification step to coarsely granulate the kneaded product to a certain particle size. A preferable method includes pelletizing the kneaded product during the solidification step following the kneading step.

In the pelletizing step, a strand-cut method, a water-cooled hot-cut method, an underwater-cut method, or the like can be used. For example, in the strand-cut method, the kneaded-melt product immediately after the kneading step is extruded through a die having a diameter of about 3 mm to form a strand, which is cooled in a cooling device such as a water tank, and then cut with a pelletizer after cooling to be processed into pellets. The particle size of the pellets can be suitably adjusted by regulating the thickness of the strand through control of the feed rate of the melt-kneaded product and the feed rate of the pelletizer, thereby adjusting the cutting width.

The particle size of the pellets is preferably 0.5 mm or more and 3 mm or less in diameter, more preferably 1 mm or more and 2 mm or less in diameter. In the coarse granulation prior to the fine pulverization step, the smaller the particle size, the higher the efficiency of fine pulverization. However, as the strand diameter decreases, the strand is more likely to break during the step, making it difficult to maintain step stability. Thus, processing at a diameter of 1 mm or more is preferable.

### —Step of Obtaining Pulverized Product of Solid Product (Fine Pulverization Step)—

Next, the obtained solid product is finely pulverized to obtain a pulverized product (fine pulverization step). The solid product can be pulverized using a known pulverization method. Examples of the pulverization method that can be used include, but are not limited to, a jet mill method in which the toner is entrained in a high-velocity air stream, and the solid product is pulverized by the energy generated when the toner collides with an impact plate, a particle collision method in which toner particles collide with each other in an air stream, a mechanical pulverization method in which the toner is fed into a narrow gap with a high-speed rotating rotor and pulverized, and a cyclone mill pulverization method in which two impellers are rotated to generate a high-velocity air stream to produce a shearing force.

In the present disclosure, it is preferable to use a cryogenic pulverization method for pulverizing the toner. A substance has the property of becoming abruptly brittle at a certain temperature or lower, which is referred to as “low-temperature brittleness”. By utilizing this property, a substance such as rubber or plastic, which is difficult to pulverize at room temperature, can also be pulverized. The “cryogenic pulverization” using liquid nitrogen at an ultralow temperature of −196° C. is also referred to as “cold pulverization” or “freeze pulverization”.

By employing the freeze pulverization method, pulverizability is greatly improved, and the shape of the pulverized particles is stabilized, making it possible to obtain a finely pulverized product more suitable for the toner. In this freeze pulverization, it is preferable to use the above-described mechanical pulverization method in which the toner is fed into a narrow gap with a high-speed rotating rotor and pulverized or the cyclone mill pulverization method in which two impellers are rotated to generate a high-velocity air stream to produce a shearing force.

Specifically, the coarsely granulated kneaded product is introduced into a cooler, cooled with liquid nitrogen, processed with a pulverizer, and sieved to obtain particles having an intended particle diameter or less. The coarse particles remaining on the sieve during sieving are returned to the cooler and pulverized again. As a cooling unit, a cooler such as a chiller can be used. The temperature of the coarse particles to be finely pulverized is preferably “glass transition point Tg of the coarse particles −5° C. or lower”, more preferably “glass transition point Tg of the coarse particles −20° C. or lower”.

### —Step of Classifying and Recovering Pulverized Product (Classification Step)—

Next, the pulverized product is classified, and the pulverized product having a predetermined volume-average particle diameter is recovered. In this manner, the toner can be obtained (classification step). A classification method is not particularly limited and can be appropriately selected depending on the purpose, such as an air-flow method or a rotary rotor method. Examples of the air-flow method include, but are not limited to, the Elbow-Jet Air Classifier (manufactured by Matsubo Corp.), and examples of the rotary rotor method include, but are not limited to, the TSP Separator and the TTSP Separator (manufactured by Hosokawa Micron Corp.).

Further, the first toner and the second toner can be produced using the solution suspension method.

When producing the toner using the solution suspension method, an oil phase in which the toner materials such as the binder resin, the release agent, and optionally the colorant and the charge control agent are dissolved or dispersed in an organic solvent is dispersed in an aqueous medium (aqueous phase), and the binder resin is reacted. This produces a dispersion liquid including a dispersion (oil droplets) including a prepolymer in which the toner materials are emulsified or dispersed. The organic solvent is then removed from the dispersion liquid, and the resulting mixture is filtered, washed, dried, and further classified as necessary to produce toner base particles. The first toner and the second toner can be obtained by granulating the base particles obtained using the solution suspension method.

The organic solvent is not particularly limited and can be appropriately selected depending on the purpose. However, the organic solvent having a boiling point of less than 150° C. is preferable because it can be easily removed.

The organic solvent having a boiling point of less than 150° C. is not particularly limited and can be appropriately selected depending on the purpose. Examples thereof include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These may be used alone or in combination of two or more types.

Of these, ethyl acetate, toluene, xylene, benzene, methylene chloride, 1,2-dichloroethane, chloroform, and carbon tetrachloride are preferable, with ethyl acetate being more preferable.

The aqueous medium is not particularly limited and can be appropriately selected depending on the purpose. Examples thereof include, but are not limited to, water, a solvent miscible with water, and a mixture thereof. These may be used alone or in combination of two or more types. Of these, water is preferable.

The solvent miscible with water is not particularly limited and can be appropriately selected depending on the purpose. Examples thereof include, but are not limited to, an alcohol, a lower ketone, dimethylformamide, tetrahydrofuran, and Cellosolve.

The alcohol is not particularly limited and can be appropriately selected depending on the purpose. Examples thereof include, but are not limited to, methanol, isopropanol, and ethylene glycol.

The lower ketone is not particularly limited and can be appropriately selected depending on the purpose. Examples thereof include, but are not limited to, acetone and methyl ethyl ketone.

A method for removing the organic solvent from the dispersion liquid is not particularly limited and can be appropriately selected depending on the purpose. Examples thereof include, but are not limited to, a method in which the entire reaction system is gradually heated to evaporate the organic solvent in the oil droplets, and a method in which the dispersion liquid is sprayed into a dry atmosphere to remove the organic solvent in the oil droplets.

In the dissolution-suspension method, classification may be performed by removing fine particle fractions in the liquid using cyclone, decanter, centrifugation, or the like, or classification operation may be performed after drying.

As a result, the toner base of the first toner and the second toner in the present disclosure can be produced.

—Step of Mixing with External Additive and Sieving Aggregates (Mixing/Sieving Step)—

In order to adjust the powder properties and charging properties required for the toner, fine particles (external additive) of silica dioxide, titanium oxide, or the like are mixed with the obtained toner base, and any aggregate that may occur during mixing is removed by sieving. As the external additive mixer, a stirring mixer is preferably used. Examples thereof include, but are not limited to, a Henschel mixer (manufactured by Mitsui Mining and Smelting Co., Ltd.), a Super Mixer (manufactured by Kawata Mfg. Co., Ltd), and a TSK mixer (manufactured by Tsukishima Kikai Co., Ltd.).

### (Image Forming Method)

An image forming method of the present disclosure is a method of forming an image in which an image is transferred onto a transfer medium by thermal pressure transfer using the transfer sheet of the present disclosure.

### <Transfer Medium>

A thermal transfer print sheet image forming method is a printing method capable of printing on a wider range of materials and shapes of transfer media than by direct printing onto the transfer medium. Printing can be performed on any material which is not a thermoplastic substance that is excessively deformed by thermal pressure transfer. Printing can be performed on a variety of materials, including paper, a plastic, fabric, leather, ceramic, glass, metal, and a painted surface.

In particular, a field in which the image forming method of the present disclosure can exhibit its effects is a garment printing field.

It is possible to form a high-quality, high-saturation image while maintaining cracking resistance and washability on a flexible and stretchable transfer medium such as a garment made of cotton, polyester, polyurethane, nylon, rayon, silk, wool, a blend of these fibers, or the like. Further, because the method conforms the deformation of a highly flexible transfer medium such as leather, a highly durable image can be obtained.

Further, since the first toner used in the image forming method of the present disclosure includes a sufficiently large amount of polyurethane resin, it is possible to form a high-strength image, thereby providing sufficient image durability when forming an image on metal, ceramic, glass, or a painted surface. As a result, custom designs and labeling can be easily applied to tableware such as a mug, a glass, and a plate, an accessory, various tools, an automobile part, a machine tool part, furniture, a signboard, and the like.

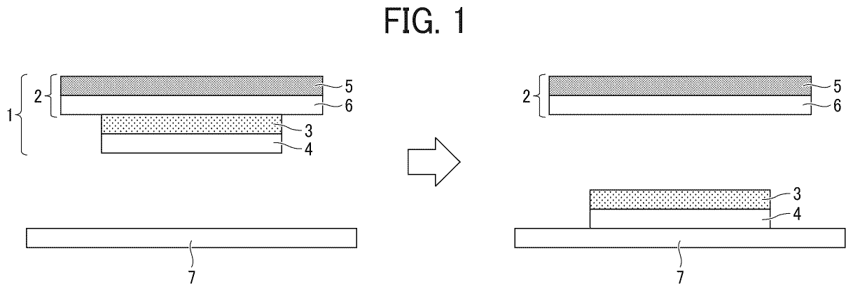

FIG. 1 is a schematic diagram illustrating the image forming method in which an image is transferred onto a transfer medium by thermal pressure transfer using a transfer sheet according to one embodiment of the present disclosure.

A transfer sheet 1 includes a release support 2, a toner layer 3 formed of the second toner, and a toner layer 4 formed of the first toner. The release support 2 includes a substrate 5 and a release layer 6.

The transfer sheet 1 is pressed against a transfer medium 7 and heated and pressurized, whereby the toner layer 3 formed of the second toner and the toner layer 4 formed of the first toner are transferred onto the transfer medium 7.

At this time, the release layer 6 is not transferred to the transfer medium 7 and remains on the substrate 5, making it possible to reuse the release support 2.

### (Transfer Sheet Production Apparatus and Transfer Sheet Production Method)

A transfer sheet production apparatus for producing the transfer sheet of the present disclosure is an electrophotographic printer with multiple development stations, each station equipped with the first toner or the second toner. The transfer sheet is produced by layering the second toner and the first toner on the surface of the release support to form a transfer image.

At each development station, it is preferable to form a toner layer having a thickness of 15 μm or more in a single pass. However, if a sufficient deposition amount cannot be obtained, the same toner is used at multiple development stations, or the number of printing passes is increased to form an image.

The required toner deposition amount varies depending on the material and brightness of the transfer medium. However, when the transfer medium has a smooth surface, even in image formation on a dark-colored (low-brightness) transfer medium, a toner thickness of 15 μm or more can prevent a decrease in saturation in a color image, thereby allows a vivid image to be obtained. At a thickness of 30 μm or more, even a clearer color image can be obtained. When the thickness exceeds 100 μm, however, it becomes difficult to set fixing conditions that prevent hot offset and cold offset, making it harder to achieve stable quality.

In the image forming method of the present disclosure, since it is not necessary to superimpose different toners, the desired design can be printed without the need to overlay toners to an excessive deposition amount.

Among the multiple development stations, all may use toners of different colors, or the same color toner may be used in the multiple development stations, with the combination being selected depending on the purpose.

When multi-color printing is intended, using different color toners reduces the frequency of color changes and increases efficiency. For printing with two or fewer colors, using a single color of toner in the multiple development stations, such as using the first color toner in the first and second development stations and the second color toner in the third and fourth development stations, allows printing at a desired toner deposition amount for each color with fewer printing passes.

Further, by using the transfer sheet production apparatus that uses a single color of toner at all development stations, it is possible to perform printing at a sufficient deposition amount for each color in a single printing pass. This eliminates the need for toner color changes and further improves efficiency. However, since this increases equipment costs and installation space, it is preferable to select such a configuration depending on the purpose and application.

The transfer sheet production apparatus for producing the transfer sheet of the present disclosure includes an electrostatic latent image bearer, an electrostatic latent image forming unit, a developing unit, a transfer unit, and a fixing unit, and may further include other units as required.

The transfer sheet production method for producing the transfer sheet of the present disclosure includes an electrostatic latent image forming step, a developing step, a transfer step, and a fixing step, and may further include other steps as necessary.

The transfer sheet production method can be suitably performed by the transfer sheet production apparatus, the electrostatic latent image forming step can be suitably performed by the electrostatic latent image forming unit, the developing step can be suitably performed by the developing unit, the transfer step can be suitably performed by the transfer unit, the fixing step can be suitably performed by the fixing unit, and the other steps can be suitably performed by the other units.

### <Electrostatic Latent Image Bearer>

The electrostatic latent image bearer is not particularly limited in terms of structure, size, and the like, and can be appropriately selected from known electrostatic latent image bearers. The shape of the electrostatic latent image bearer is not particularly limited and can be selected appropriately depending on the purpose. Examples thereof include, but are not limited to, a drum shape and a belt shape. A material for the electrostatic latent image bearer is not particularly limited and can be selected appropriately depending on the purpose. Examples thereof include, but are not limited to, an inorganic photoconductor such as amorphous silicon or selenium, and an organic photoconductor (OPC) such as polysilane or phthalopolymethine.

Examples of the organic photoconductor include a laminated photoconductor having a laminated structure in which a layer (charge generation layer) in which a charge generation material such as metal-free phthalocyanine or titanyl phthalocyanine is dispersed in a binder resin and a layer (charge transport layer) in which a charge transport material is dispersed in a binder resin are stacked on a support such as an aluminum drum, and a single-layer photoconductor having a single-layer photoconductor layer in which both a charge generation material and a charge transport material are dispersed in a binder resin on a support.

In a single-layer photoconductor, a hole transport agent and an electron transport agent can be added to the photoconductor layer as charge transport materials.

Further, an undercoat layer may be provided between the support and the laminated charge generation layer or the single-layer photoconductor layer.

The shape of the electrostatic latent image bearer is not particularly limited and can be appropriately selected depending on the purpose. However, a cylindrical shape is preferable. The outer diameter of the cylindrical electrostatic latent image bearer is not particularly limited and can be appropriately selected depending on the purpose. However, the outer diameter is preferably 3 mm to 100 mm, particularly preferably 20 mm to 50 mm.

### <Electrostatic Latent Image Forming Unit and Electrostatic Latent Image Forming Step>

The electrostatic latent image forming unit is a unit for forming an electrostatic latent image on the electrostatic latent image bearer. The electrostatic latent image forming unit is not particularly limited and can be selected appropriately depending on the purpose. Examples thereof include, but are not limited to, a unit having at least a charging member that charges the surface of the electrostatic latent image bearer and an exposing member that exposes the surface of the electrostatic latent image bearer to light in an image pattern.

The electrostatic latent image forming step is a step for forming an electrostatic latent image on the electrostatic latent image bearer. The electrostatic latent image forming step is not particularly limited and can be appropriately selected depending on the purpose. For example, the electrostatic latent image forming step can be performed by charging the surface of the electrostatic latent image bearer and then exposing it to light in an image pattern, using the electrostatic latent image forming unit.

### —Charging Member and Charging—

The charging member is not particularly limited and can be appropriately selected depending on the purpose. Examples thereof include, but are not limited to, a known contact charger equipped with a conductive or semiconductive roller, brush, film, rubber blade, or the like, and a non-contact charger that utilizes corona discharge, such as corotron or scorotron.

The charging can be performed, for example, by applying a voltage to the surface of the electrostatic latent image bearer using the charging member.

As the shape of the charging member, any form may be adopted, such as a roller, a magnetic brush, or a fur brush, and it can be selected according to the specifications and configuration of the image forming apparatus.

The charging member is not limited to the contact charging member, but it is preferable to use the contact charging member as this makes it possible to obtain the image forming apparatus in which the amount of ozone generated from the charging member is reduced.

### —Exposing Member and Exposure—

The exposing member is not particularly limited as long as it can expose the surface of the electrostatic latent image bearer charged by the charging member to light in an image pattern to be formed, and can be appropriately selected depending on the purpose. Examples thereof include, but are not limited to, various exposing members such as a copying optical system, a rod lens array system, a laser optical system, and a liquid crystal shutter optical system.

A light source used in the exposing member is not particularly limited and can be appropriately selected depending on the purpose. Examples thereof include, but are not limited to, a general light-emitting element such as a fluorescent lamp, a tungsten lamp, a halogen lamp, a mercury lamp, a sodium lamp, a light-emitting diode (LED), a laser diode (LD), or electroluminescence (EL).

Further, in order to apply only light in a desired wavelength range, various filters such as a sharp cut filter, a band pass filter, a near infrared cut filter, a dichroic filter, an interference filter, and a color temperature conversion filter can be used.

The exposure can be performed, for example, by exposing the surface of the electrostatic latent image bearer to light in an image pattern using the exposing member.

Note that, in the present disclosure, a backlight system may be employed in which the exposure is performed in an image pattern from the back side of the electrostatic latent image bearer.

### <Developing Unit and Developing Step>

The developing unit is a unit for developing the electrostatic latent image with a developer including a toner to form a toner image. The developing unit is not particularly limited and can be appropriately selected depending on the purpose.

The developing step is a step for developing the electrostatic latent image with a developer including a toner to form a toner image. The developing step is not particularly limited and can be appropriately selected depending on the purpose, and can be performed, for example, by the developing unit.

The developing unit is preferably a developing device including an agitator that frictionally agitates the toner to charge it, a magnetic field generator fixed inside, and a rotatable developer carrier that carries a developer including the toner on its surface.

In the developing unit, for example, the toner and the carrier are mixed and agitated, and the toner is charged by friction during this process and held in a standing state on the surface of a rotating magnet roller, forming a magnetic brush. The magnet roller is disposed near the electrostatic latent image bearer. Thus, a part of the toner constituting the magnetic brush formed on the surface of the magnet roller moves to the surface of the electrostatic latent image bearer by electrical attraction. As a result, the electrostatic latent image is developed with the toner, and a visible image formed of the toner is formed on the surface of the electrostatic latent image bearer.

### <Transfer Unit and Transfer Step>

The transfer unit is a unit for transferring the toner image formed on the electrostatic latent image bearer to a release support. The transfer unit is not particularly limited and can be selected appropriately depending on the purpose. However, a preferable mode includes a primary transfer unit for transferring the toner image onto an intermediate transfer body to form a composite transfer image, and a secondary transfer unit for transferring the composite transfer image onto the release support.

The transfer step is a step for transferring the toner image formed on the electrostatic latent image bearer to a release support. The transfer step is not particularly limited and can be appropriately selected depending on the purpose. However, it is preferable to employ a mode in which an intermediate transfer body is used, the toner image is primarily transferred onto the intermediate transfer body to form a composite transfer image, and the composite transfer image is then secondarily transferred onto the release support.

The transfer step can be performed, for example, by charging the photoconductor with a transfer charger, thereby transferring the toner image, and can be performed by the transfer unit.

In the case where the image secondarily transferred onto the release support is an image composed of two types of toners, namely transparent toner and white toner, the primary transfer unit can be configured to sequentially superimpose the two types of toners on the intermediate transfer body to form an image on the intermediate transfer body, and the secondary transfer unit can be configured to collectively secondarily transfer the image on the intermediate transfer body onto the release support.

Note that the intermediate transfer body is not particularly limited and can be appropriately selected from known transfer bodies depending on the purpose. Preferable examples thereof include, but are not limited to, a transfer belt.

The transfer unit (the primary transfer unit and the secondary transfer unit) preferably includes at least a transfer device that applies separation charging to transfer the toner image formed on the photoconductor onto the release support side. Examples of the transfer device include, but are not limited to, a corona transfer device that uses corona discharge, a transfer belt, a transfer roller, a pressure transfer roller, and an adhesive transfer device.

### <Fixing Unit and Fixing Step>

The fixing unit is a unit for fixing the toner image transferred onto the release support. The fixing unit is not particularly limited and can be selected appropriately depending on the purpose. However, a known heating and pressure member is preferable. Examples of the heating and pressure member include, but are not limited to, a combination of a heating roller and a pressure roller, and a combination of a heating roller, a pressure roller, and an endless belt.

The fixing step is a step for fixing the toner image transferred onto the release support. The fixing step is not particularly limited and can be selected appropriately depending on the purpose. The fixing step may be performed simultaneously in a single operation in a state where the toner layer of each color is stacked by the corresponding developing unit. The fixing step can be performed by the fixing unit.

The heating in the heating and pressing member is usually preferably 80° C. to 200° C. Note that, in the present disclosure, depending on the purpose, for example, a known optical fixing device may be used together with, or in place of, the fixing unit.

The surface pressure in the fixing step is not particularly limited and can be appropriately selected depending on the purpose. However, the surface pressure is preferably 10 N/cm² to 80 N/cm².

### <Other Units and Other Steps>

Examples of the other units include, but are not limited to, a cleaning unit, a static elimination unit, a recycling unit, and a control unit.

Examples of the other steps include, but are not limited to, a cleaning step, a static elimination step, a recycling step, and a control step.

### <<Cleaning Unit and Cleaning Step>>

The cleaning unit is a unit for removing the toner remaining on the photoconductor. The cleaning unit is not particularly limited and can be appropriately selected depending on the purpose. Examples thereof include, but are not limited to, a magnetic brush cleaner, an electrostatic brush cleaner, a magnetic roller cleaner, a blade cleaner, a brush cleaner, and a web cleaner.

The cleaning step is a step for removing the toner remaining on the photoconductor. The cleaning step is not particularly limited and can be appropriately selected depending on the purpose. For example, the cleaning step can be performed by the cleaning unit.

### <<Static Elimination Unit and Static Elimination Step>>

The static elimination unit is a unit for removing charge by applying a charge removal bias to the photoconductor. The static elimination unit is not particularly limited and can be appropriately selected depending on the intended purpose. Examples thereof include, but are not limited to, a charge removal lamp.

The static elimination step is a step for removing charge by applying a charge removal bias to the photoconductor. The static elimination step is not particularly limited and can be appropriately selected depending on the intended purpose. For example, the static elimination step can be performed by the static elimination unit.

### <<Recycling Unit and Recycling Step>>

The recycling unit is a unit for recycling the toner removed by the cleaning unit into the developing device. The recycling unit is not particularly limited and can be appropriately selected depending on the purpose. Examples thereof include, but are not limited to, a known transport unit.

The recycling step is a step for recycling the toner removed by the cleaning step into the developing device. The recycling step is not particularly limited and can be appropriately selected depending on the purpose. For example, the recycling step can be performed by the recycling unit.

### <<Control Unit and Control Step>>

The control unit is a unit for controlling the operation of each unit. The control unit is not particularly limited and can be appropriately selected depending on the purpose. Examples thereof include, but are not limited to, a device such as a sequencer or a computer.

The control step is a step of controlling the operation of each step. The control step is not particularly limited and can be appropriately selected depending on the purpose. For example, the control step can be performed by the control unit.

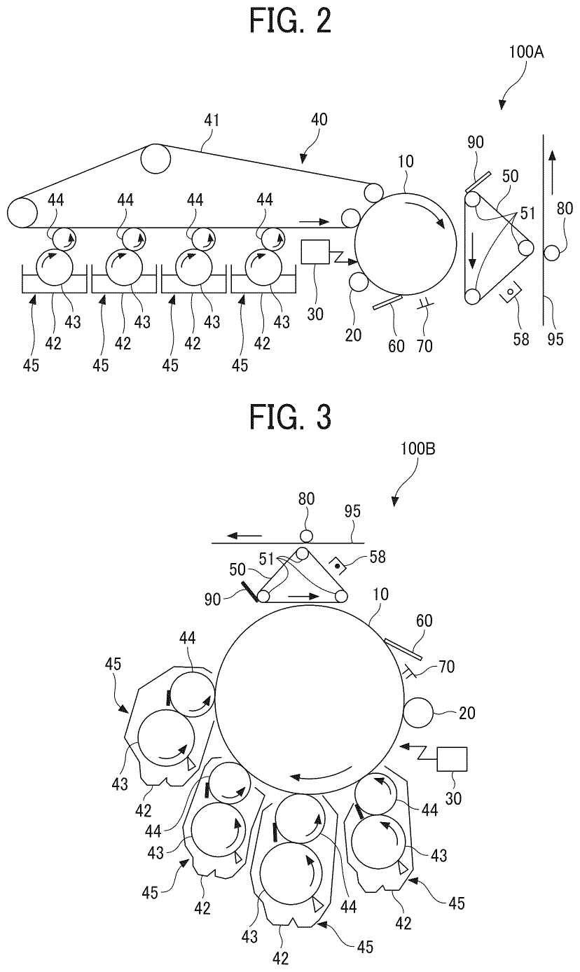

Next, the transfer sheet production apparatus for producing the transfer sheet of the present disclosure is described with reference to FIGS. 2 to 5.

FIG. 2 is a schematic diagram illustrating an example of the transfer sheet production apparatus for producing the transfer sheet according to one embodiment of the present disclosure. A transfer sheet production apparatus 100A includes a photoconductor drum 10 (hereinafter sometimes referred to as “photoconductor 10”) as the electrostatic latent image bearer, a charging roller 20 as a charging unit, an exposing device 30 as an exposing unit, a developing device 40 as the developing unit, an intermediate transfer body 50, a cleaning device 60 as the cleaning unit including a cleaning blade, and a charge removal lamp 70 as the static elimination unit.

The intermediate transfer body 50 is an endless belt that is designed to be movable in the direction of the arrow by three rollers 51 disposed inside the belt to stretch it. Some of the three rollers 51 also function as a transfer bias roller that can apply a predetermined transfer bias (primary transfer bias) to the intermediate transfer body 50. A cleaning device 90 having a cleaning blade is disposed near the intermediate transfer body 50. Further, near the intermediate transfer body 50, a transfer roller 80 serving as the transfer unit that can apply a transfer bias for transferring (secondary transfer) the toner image to a transfer sheet 95 serving as a recording medium is disposed so as to face the intermediate transfer body 50. A corona charger 58 for applying an electric charge to the toner image on the intermediate transfer body 50 is disposed around the intermediate transfer body 50 between the contact point of the photoconductor 10 and the intermediate transfer body 50 and the contact point of the intermediate transfer body 50 and the transfer sheet 95 in the rotation direction of the intermediate transfer body 50.

The developing device 40 is composed of a developing belt 41 as the developer carrier and four developing units 45 arranged in parallel around the developing belt 41. Each developing unit 45 includes a developer container 42, a developer supply roller 43, and a developing roller 44. Further, the developing belt 41 is an endless belt that is rotatably stretched around a plurality of belt rollers, and a part of the developing belt 41 contacts the electrostatic latent image bearer 10. Note that the color of the toners of the developers contained in the four developer containers 42 is not particularly limited. Further, the number of the developer units 45 is not particularly limited.

In the transfer sheet production apparatus 100A illustrated in FIG. 2, for example, the charging roller 20 uniformly charges the photoconductor drum 10. The exposing device 30 exposes the photoconductor drum 10 to light in an image pattern to form an electrostatic latent image. The electrostatic latent image formed on the photoconductor drum 10 is developed by supplying the toner from the developing device 40 to form a toner image. The toner image is transferred (primary transfer) onto the intermediate transfer body 50 by a voltage applied from the roller 51, and further transferred (secondary transfer) onto the release support 95. As a result, a transfer image is formed on the release support 95. Note that residual toners on the photoconductor 10 are removed by the cleaning device 60, and the charge on the photoconductor 10 is temporarily removed by the charge removal lamp 70.

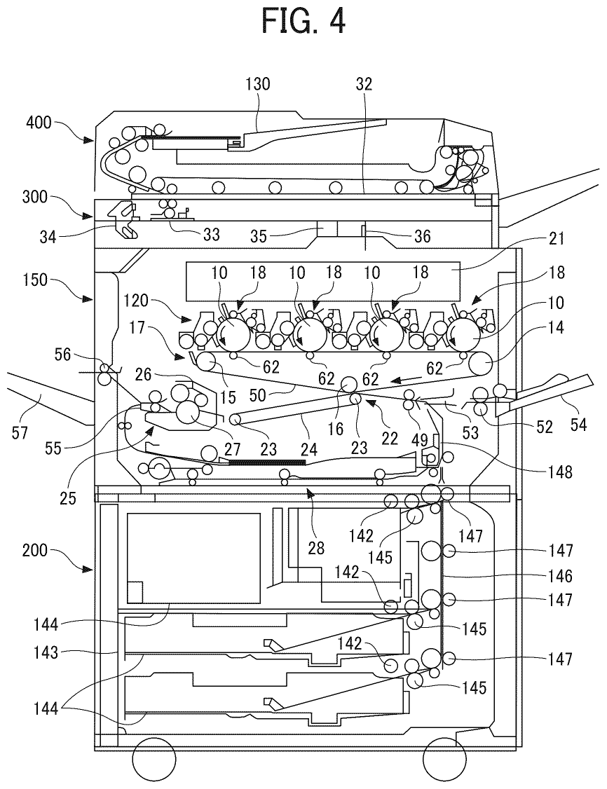

FIG. 3 and FIG. 4 are schematic diagrams illustrating another example of the transfer sheet production apparatus for producing the transfer sheet according to one embodiment of the present disclosure. A transfer sheet production apparatus 100B in FIG. 3 has the same configuration as the transfer sheet production apparatus 100A illustrated in FIG. 2, except that four developing units 45 are disposed so as to directly face the periphery of the photoconductor drum 10 without providing the developing belt 41.

The transfer sheet production apparatus illustrated in FIG. 4 includes a copying machine main body 150, a paper feed table 200, a scanner 300, and an automatic document feeder (ADF) 400.

The endless belt-like intermediate transfer body 50 is provided in the center of the copying machine main body 150.

The intermediate transfer body 50 is stretched around support rollers 14, 15, and 16 and is rotatable clockwise in FIG. 4. An intermediate transfer body cleaning device 17 is disposed near the support roller 15 to remove residual toners on the intermediate transfer body 50. The intermediate transfer body 50 is stretched around the support roller 14 and the support roller 15, and is provided with a tandem developing device 120 in which four image forming units 18, that is, first, second, third and fourth, are arranged in parallel along the transport direction so as to face the intermediate transfer body 50. An exposing device 21, which is the exposing member, is disposed near the tandem developing device 120. A secondary transfer device 22 is disposed on the side of the intermediate transfer body 50 opposite to the side on which the tandem developing device 120 is disposed. In the secondary transfer device 22, a secondary transfer belt 24, which is an endless belt, is stretched around a pair of rollers 23, and a transfer sheet transported on the secondary transfer belt 24 can come into contact with the intermediate transfer body 50. A fixing device 25, which serves as the fixing unit, is disposed near the secondary transfer device 22. The fixing device 25 includes a fixing belt 26, which is an endless belt, and a pressure roller 27 that is disposed so as to be pressed against the fixing belt 26.

Note that, in a tandem image forming apparatus, a sheet inverting device 28 is disposed near the secondary transfer device 22 and the fixing device 25 to invert the release support in order to form images on both sides of the release support.

Next, the image formation using the tandem developing device 120 is described. Specifically, first, an original document is set on a platen 130 of the automatic document feeder (ADF) 400, or the automatic document feeder 400 is opened and the original document is set on a contact glass 32 of the scanner 300, and then the automatic document feeder 400 is closed.

When a start switch is pressed, if an original document is set to the automatic document feeder 400, the scanner 300 is driven after the original document is transported and moved onto the contact glass 32, but if an original document is set on the contact glass 32, the scanner 300 is driven immediately. Then, a first traveling body 33 and a second traveling body 34 travel. At this time, light from the light source is applied by the first traveling body 33, and the light reflected from the original document surface is reflected by a mirror on the second traveling body 34, and is received by a reading sensor 36 through an imaging lens 35. In this manner, the color original document (color image) is read, and image information of a first color, a second color, a third color, and a fourth color is obtained to create a solid image in which all colors are deposited in the same amount.

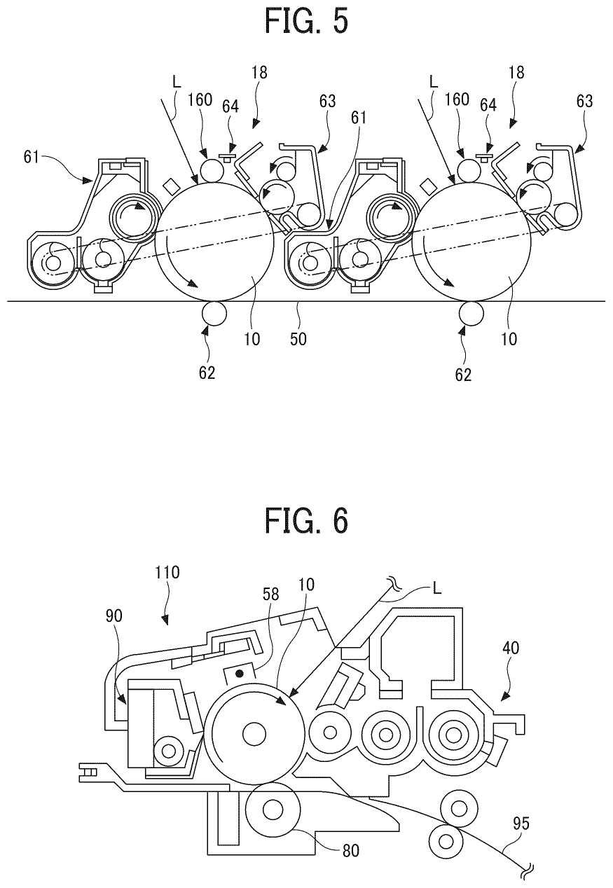

The solid image information is then transmitted to the image forming units 18 (first image forming unit, second image forming unit, third image forming unit, and fourth image forming unit) in the tandem developing device 120. Then, in each image forming unit, an image consistent among the image forming unit is formed by the corresponding image forming unit. That is, as illustrated in FIG. 5, each of the image forming units 18 (first color image forming unit, second color image forming unit, third color image forming unit, and fourth color image forming unit) in the tandem developing device 120 includes the electrostatic latent image bearer 10, a charging device 160 which is the charging unit for uniformly charging the electrostatic latent image bearer 10, the exposing device which exposes the electrostatic latent image bearer to light (L in FIG. 5) in an image pattern corresponding to the solid image based on the solid image information, and forms an electrostatic latent image corresponding to the image on the electrostatic latent image bearer, a developing device 61 which is the developing unit for developing the electrostatic latent image using each toner for transfer sheet to form a color image with each toner for transfer sheet, a transfer charger 62 which transfers the toner image onto the intermediate transfer body 50, a cleaning device 63, and a static eliminator 64. Then, each image forming unit 18 forms a single-color image (first color image, second color image, third color image, and fourth color image) based on the corresponding color image information. The first color image, the second color image, the third color image, and the fourth color image thus formed are sequentially transferred (primary transfer) onto the intermediate transfer body 50, which is rotated and moved by the support rollers 14, 15, and 16, to form a color image.

Meanwhile, in the paper feed table 200, one of the paper feed rollers 142 is selectively rotated to feed out the release support from one of paper feed cassettes 144 provided in multiple stages in a paper bank 143. The release supports are separated one by one by a separation roller 145, fed into a paper feed path 146, conveyed by a transport roller 147, guided into a paper feed path 148 inside the copying machine main body 150, and stopped upon abutting against a registration roller 49. Alternatively, the paper feed roller 142 is rotated to feed out the release support placed on a manual feed tray 54. The release supports are separated one by one by a separation roller 52, fed into a manual paper feed path 53, and stopped upon abutting against the registration roller 49 in the same manner. Note that the registration roller 49 is generally used in a grounded state, but may be also applied with a bias to remove paper dust of the release support. Then, the registration roller 49 is rotated in synchrony with the color image synthesized on the intermediate transfer body 50 to send the release support between the intermediate transfer body 50 and the secondary transfer device 22, so that the color image is transferred (secondary transfer) onto the release support by the secondary transfer device 22. In this manner, the color image is transferred onto the release support. Note that after the image transfer, any remaining toner on the intermediate transfer body 50 is cleaned by the intermediate transfer body cleaning device 17.

The release support onto which the color image has been transferred is transported by the secondary transfer device 22 and sent to the fixing device 25, where the color image (transfer material adhesion transfer image) is fixed onto the release support by heat and pressure to form a transfer sheet. Thereafter, the transfer sheet is switched by a switching claw 55, ejected by an ejection roller 56, and stacked on a paper ejection tray 57. Alternatively, the transfer sheet can be switched by the switching claw 55, inverted by a sheet inverting device 28, and guided to the transfer position again, where an image is recorded on the back side as well, and then ejected by the ejection roller 56 and stacked on the paper ejection tray 57.

### (Process Cartridge)

A process cartridge of the present disclosure is molded to be detachably mountable on various transfer sheet production apparatuses. The process cartridge includes at least an electrostatic latent image bearer that carries an electrostatic latent image, and a developing unit that develops the electrostatic latent image carried on the electrostatic latent image bearer with a developer including a toner to form a toner image.

Note that the process cartridge may further include other units as needed.

The developing unit includes at least a developer container for containing a developer and a developer carrier for carrying and transporting the developer contained in the developer container. Note that the developing unit may further include a regulating member or the like for regulating the thickness of the developer carried.

FIG. 6 is a schematic diagram illustrating an example of the process cartridge according to the present disclosure. A process cartridge 110 includes a photoconductor drum 10, a corona charger 58, a developing device 40, a transfer roller 80, and a cleaning device 90.

### (Thermal Pressure Transfer Device)

A thermal pressure transfer device is a device that thermally and pressure-transfers the transfer sheet of the present disclosure onto a transfer medium such as fabric or leather, and is capable of applying heat for a predetermined period of time under uniform pressure on a pressing surface. Such a device is also referred to as an iron press machine or a heat press machine.

The thermal pressure transfer device used in the present disclosure may be any commonly commercially available device. When creating a T-shirt or the like, it is preferable that the area of the press surface is larger than the area of the transfer medium. By applying uniform heat and pressure to the front surface of the transfer medium, a transfer image can be obtained without leaving any press marks on the transfer medium. Specific examples of the thermal pressure transfer device include, but are not limited to, GFH-380, GHP-300 (all from SystemGraphi Co., Ltd), HPT234PS1, HSP-5400, HP-4536A-12, HP-54A, HP-84A, HSP-1513PV-AT, HSP-1010 (all from Hashima), TS-ONE (Siser S.r.l.), TP630M, and TP700A (Horizon International Inc.). Alternatively, a commercially available iron can be used.

The temperature for thermal pressure transfer varies depending on the material and thickness of the transfer medium, but it is preferable that the temperature is higher than the softening point of the toner and 20° C. lower than the heat resistance temperature of the transfer medium.

The pressure for thermal pressure transfer is preferably low as long as transfer is possible, and is preferably 1000 g/cm² or less, more preferably 600 g/cm², even more preferably 300 g/cm² or less.

### EXAMPLES

The following describes examples of the present disclosure, but the present disclosure is not limited to these examples.

### (Production of First Toner)

### [Production Example of Toner 1]

### —Raw Materials for Toner 1—

Polyurethane elastomer (E780M128, manufactured by Nippon Miractran Co, Ltd., softening point: 118° ° C., glass transition temperature: −24° C.) 50% by weight
Polyester resin RN-306SF (manufactured by Kao Corp., softening temperature: 100° C., glass transition temperature: 60° C.) 20% by weight
Wax dispersant (EXD-001, manufactured by Sanyo Chemical Industries, Ltd.) 2.5% by weight
Ester wax (LW-13, manufactured by Sanyo Chemical Industries, Ltd.) 2.5% by weight
Titanium dioxide white pigment (PF-739, manufactured by Ishihara Sangyo Kaisha, Ltd.) 25% by weight

The above raw materials for the toner 1 were premixed using a Henschel mixer (manufactured by Nippon Coke & Engineering. Co., Ltd., FM20B), and then melted and kneaded at a temperature set to 90° C. in a batch kneader (manufactured by Nihon Spindle Manufacturing Co., Ltd., WONDER KNEADER “WDS7-30”). The resulting kneaded product was extruded through a 3 mm diameter die using a feeder ruder to form a strand, which was cooled in a water bath with a water temperature of 15° C. or lower and solidified. The strand was then cut using a pelletizer to obtain toner pellets 2 mm in diameter and 2 mm long. These pellets are a toner component melt-kneaded coarsely pulverized product.

Next, the toner pellets were placed in a cooling machine and cooled with liquid nitrogen, and pulverized in a mechanical pulverizer (Linrex Mill LX manufactured by Hosokawa Micron Corp.). The pulverized product coming out of the pulverizer was sieved through a 25 μm mesh, and the non-passing material was fed back into the pulverizer to obtain fine particles that passed through the 25 mesh.

The fine particles that passed through the 25 mesh were returned to room temperature and then finely classified in an air classifier (manufactured by Matsubo Corp., EJ-LABO) by appropriately adjusting the louver opening so that particles of 5 μm or less constituted 10% or less by number, yielding toner base particles.

Next, 100 parts by mass of the obtained toner base particles were mixed by stirring with 1.0 part by mass of an additive 1 (HDK-2000, manufactured by Clariant, substance name: silica) and 1.0 part by mass of an additive 2 (H05TD, manufactured by Clariant, substance name: silica) using a Henschel mixer to produce [Toner 1]. The Tg of [Toner 1] was −19.6° C.

### [Production Example of Toner 2]

### —Raw Materials for Toner 2—

Polyurethane elastomer (57F, manufactured by BASF, softening point: 116° C., glass transition temperature: −26.5° C.) 60% by weight
Polyester resin RN-306SF (manufactured by Kao Corp., softening temperature: 100° C., glass transition temperature: 60° C.) 35% by weight
Wax dispersant (EXD-001, manufactured by Sanyo Chemical Industries, Ltd.) 2.5% by weight
Ester wax (LW-13, manufactured by Sanyo Chemical Industries, Ltd.) 2.5% by weight

[Toner 2] was produced in the same manner as the toner 1, except that the above-mentioned raw materials for the toner 2 were used. The Tg of [Toner 2] was −25.3° C.

### [Production Example of Toner 3]

### —Raw Materials for Toner 3—

Polyurethane elastomer (57F, manufactured by BASF, softening point: 116° C., glass transition temperature: −26.5° ° C.) 60% by weight
Polyester resin RN-306SF (manufactured by Kao Corp., softening temperature: 100° C., glass transition temperature: 60° C.) 25% by weight
Wax dispersant (EXD-001, manufactured by Sanyo Chemical Industries, Ltd.) 2.5% by weight
Ester wax (LW-13, manufactured by Sanyo Chemical Industries, Ltd.) 2.5% by weight
Carbon black (#44 manufactured by Mitsubishi Chemical Group Corp.) 10% by weight

[Toner 3] was produced in the same manner as the toner 1, except that the above-mentioned raw materials for the toner 3 were used. The Tg of [Toner 3] was −24.0° C.

### <Toner Cross-Section Observation>

The presence or absence of a sea-island structure in [Toners 1 to 3] was confirmed by observing a backscattered electron image of each toner particle cross-section (cut after cooling with liquid nitrogen) using a scanning electron microscope (SEM). The presence of sea and island regions (incompatible domains) can be confirmed by the color difference between the polyester and urethane. To enhance contrast and facilitate the distinction between the island and sea regions, staining with ruthenium tetroxide (substance name: ruthenium tetroxide, manufactured by TAAB) was performed as necessary. For each ruthenium-stained toner component melt-kneaded coarsely pulverized product, an SEM image of a particle cross-section of the toner component melt-kneaded coarsely pulverized product at approximately the midpoint of the particle diameter was taken under the following conditions, and the presence or absence of sea-island structure was confirmed. The procedure is as follows.

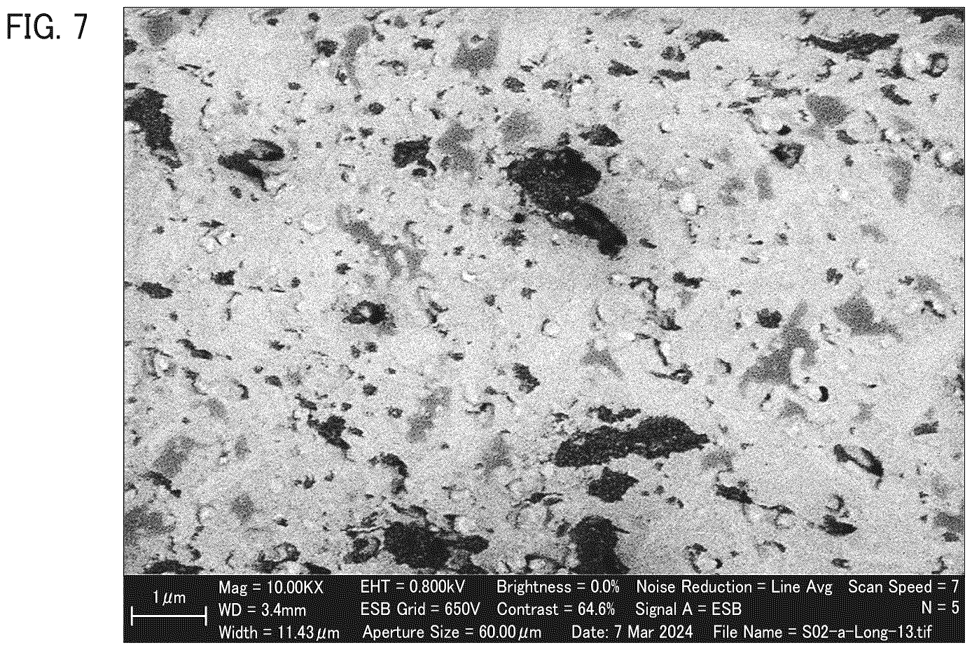

Each particle of the toner component melt-kneaded coarsely pulverized product of [Toners 1 to 3] was embedded in epoxy resin and observed using a scanning electron microscope (manufactured by Hitachi, Ltd., SU8230) under the following conditions. In this case, unstained regions are observed as dark regions, making it possible to distinguish them from stained regions (light regions). FIG. 7 is an average cross-sectional SEM image of the toner component melt-kneaded coarsely pulverized product particle.
Acceleration voltage: 5 kV
Emission current: 10 μA
Probe current: Normal
Condenser lens 1:5.0.
W.D.: 8.0 mm
Observation mode: SE
Magnification: ×2,000 or ×5,000

When SEM images of [Toners 1 to 3] were observed using the above procedure, domains with a sea-island structure were observed in all toners.

### <Matrix and Domain Composition>

For the cross-section of the toner component melt-kneaded coarsely pulverized product of the toner in which a sea-island structure was confirmed, as well as the cross-section of the resulting fixed image, the substances included in the matrix (sea regions) and the domains (island regions) were identified by compositional analysis using GC-MS and NMR.

### <<Compositional Analysis by GC-MS>>

### —Sample Preparation—

The toner component melt-kneaded coarsely pulverized product of each toner was dispersed in chloroform and stirred overnight to obtain a dispersion liquid. This dispersion liquid was then centrifuged, and only the supernatant was collected. The collected supernatant was evaporated to dryness and analyzed for composition using a gas chromatograph mass spectrometer (GC-MS). The GC-MS measurement conditions are as follows. Note that a mixture obtained by dropping about 1 μL of a methylating agent (20% methanol solution of tetramethylammonium hydroxide: TMAH) onto a specimen of about 1 mg was used as a sample.

### —Measurement Conditions—

Pyrolysis-gas chromatography mass spectrometer (Py-GCMS) analyzer: QP2010 (manufactured by Shimadzu Corp.)
Heating furnace: Py2020D (manufactured by Frontier Laboratories Ltd.)
Heating temperature: 320° C.
Column: Ultra ALLOY-5 (L=30 m, I.D-0.25 mm, Film=0.25 μm, manufactured by GL Sciences Inc.)
Column temperature: 50° C. (hold time: 1 min)−heating (10° C./min)−340° C. (hold time: 7 min)
Split ratio: 1:100
Column flow rate: 1.0 ml/min
Ionization method: EI method (70 eV)
Measurement mode: scan mode
Search data: NIST 20 Mass Spectral Library

### <<Compositional Analysis by NMR>>

### —Sample Preparation—

The toner component melt-kneaded coarsely pulverized product of each toner was dispersed in chloroform and stirred overnight to obtain a dispersion liquid. This dispersion liquid was then centrifuged, and only the supernatant was collected. The collected supernatant was evaporated to dryness and used as samples for ¹H-NMR and ¹³C-NMR by subjecting it to compositional analysis by NMR. A sample preparation method for ¹H-NMR and a sample preparation method for ¹³C-NMR, as well as measurement conditions, are as follows.

### (1) Sample Preparation Method for ¹H-NMR

A ¹H-NMR sample was prepared by adding 1 mL of d₈-toluene (manufactured by FUJIFILM Wako Pure Chemical Corp.) to 100 mg of the specimen, followed by heating with a dryer to dissolve the specimen.

(2) Sample preparation method for ¹³C-NMR

A ¹³C-NMR sample was prepared by adding 1 mL of deuterated 1,2-dichlorotoluene (manufactured by FUJIFILM Wako Pure Chemical Corp.) to 100 mg of the specimen, followed by heating with a dryer to dissolve the specimen.

### —Measurement Conditions—

NMR instrument: ECX-500 (manufactured by JEOL Ltd.)
Measurement nucleus=¹H (500 MH2), measurement pulse file=single pulse dec.jxp (¹H), 45° C. pulse, 20,000 times scans, relaxation delay 4 seconds, data points 32K, offset 100 ppm, observation width=250 ppm, measurement temperature 70° C.
Measurement nucleus=¹³C (125 MHz), measurement pulse file=single pulse dec.jxp (¹³C), 45° C. pulse, 64 times scans, relaxation delay 5 seconds, data points 32K, observation width=15 ppm, measurement temperature 65° C.

In the above <Compositional analysis by GC-MS>> and <Compositional analysis by NMR>>, the resin component with the higher content was determined as the matrix, and the resin component with the lower content was determined as the domain.

### <Production of Carrier>

### —Raw Materials for Carrier—

IP solvent 710 parts by mass.
ECF-800 (manufactured by Titan Kogyo, Ltd., mixed fine particles of aluminum oxide, tin oxide, and phosphorus pentoxide) 220 parts by mass.
R5T (manufactured by Dow Toray Co., Ltd., silicone/acrylic resin/toluene solution) parts by mass.
RCF-2130 (manufactured by Dow Toray Co., Ltd., polyalkenylsiloxane/toluene solution) 400 parts by mass
CTC-754 (manufactured by Matsumoto Fine Chemical Co., Ltd., titanium isopropoxybis(ethyl acetate)) 45 parts by mass.
RSH-602 (manufactured by Dow Toray Co., Ltd., N-(2-aminoethyl)aminopropyltrimethoxysilane) 5 parts

The above carrier raw materials were dispersed in a homomixer for 20 minutes to prepare a resin layer coating liquid. Using a fluidized bed coating device, the resin layer coating liquid was applied to the surface of 7,200 parts by mass of spherical manganese-magnesium ferrite with an average particle diameter of 70 μm to produce a carrier.

### <Production of Developer>

[Developers 1 to 3] were produced by mixing 7 parts by mass of each of the produced toners and 93 parts by mass of the above carrier using a ball mill.

### <Release Support>

[Release supports 1 to 10] listed in Table 1 were prepared as the release supports. (All products were manufactured by Lintec Corp., A4 size.)

### <<Measurement of Peeling Force of Release Support>>

An acrylic adhesive tape “31B #25” manufactured by Nitto Denko Corp. was applied to the release-treated surface using a 2-kg roller, and the peeling force after 30 minutes was measured (tape peel, peeling angle: 180°, peeling speed: 0.3 m/min).

Table 1 presents the substrate type, release layer type, basis weight, and peeling force of [Release supports 1 to 10].

TABLE 1

| | | Release | Basis | |
|---|---|---|---|---|
| | | layer | weight | Peeling force |
| | Substrate type | type | [g] | [mN/25 mm] |
| Release | Glassine paper | N97 | 70 | 254 |
| support 1 | | | | |
| Release | Glassine paper | T8 | 85 | 312 |
| support 2 | | | | |
| Release | Glassine paper | 12 | 120 | 1548 |
| support 3 | | coatings | | |
| Release | High-quality paper + | 85B1 | 150 | 1982 |
| support 4 | barrier layer (PE) | | | |
| Release | Kraft paper ÷ barrier | TS | 85 | 297 |
| support 5 | layer (PE) | | | |
| Release | Glassine paper | 85A | 85 | 520 |
| support 6 | | | | |
| Release | Glassine paper | 12 | 85 | 1284 |
| support 7 | | coatings | | |
| Release | Glassine paper | T3 | 85 | 2483 |
| support 8 | | | | |
| Release | Glassine paper | N138D | 85 | 193 |
| support 9 | | | | |
| Release | Glassine paper | N103 | 70 | 78 |
| support 10 | | | | |

### Example 1

Using [Release support 1] and [Toners 1 to 3], evaluation images 1 to 6 were produced by the following method.

### <Production of Evaluation Image 1>

In the fifth station of RICOH Pro C7200S (manufactured by Ricoh), RICOH Pro Toner White C7100 was set as the second toner, and a left-right inverted image of an image A was output onto [Release support 1].

Subsequently, all stations of RICOH Pro C5300S (manufactured by Ricoh) were replaced with developing units modified to use [Developer 1] including [Toner 1]. A full solid image of [Toner 1] was then output onto the left-right inverted image of the image A that had been output on [Release support 1], thereby producing a transfer sheet. The thickness of the [Toner 1] solid image layer at this time was 100 μm.

As the transfer medium, a black T-shirt (manufactured by United Athle, 4.7-ounce, dry silky touch T-shirt, low bleeding) was overlaid with the surface of the [Toner 1A] solid image layer on the transfer sheet, set in a heat press machine (manufactured by Piotec Co., Ltd., Model HTP234PS1), and subjected to heat and pressure at a temperature of 130° C. for 20 seconds under a pressure of 300 g/cm². Thereafter, while still warm, [Release support 1] was peeled off to obtain [Evaluation image 1].

### <Production of Evaluation Image 2>

[Evaluation image 2] was produced in the same manner as [Evaluation image 1], except that [Release support 1] was cooled to room temperature before peeling in the production of [Evaluation image 1].

### <Production of Evaluation Image 3>

[Evaluation image 3] was produced in the same manner as [Evaluation image 1], except that [Toner 2] was used instead of [Toner 1], and a white T-shirt (manufactured by United Athle, 4.7-ounce, dry silky touch T-shirt) was used as the transfer medium in the production of [Evaluation image 1].

### <Production of Evaluation Image 4>

[Evaluation image 4] was produced in the same manner as [Evaluation image 3], except that [Release support 1] was cooled to room temperature before peeling in the production of [Evaluation image 3].

### <Production of Evaluation Image 5>

In the RICOH Pro C7200S (manufactured by Ricoh), RICOH Pro Toner Gold C7200 was set in the first station and RICOH Pro Toner Silver C7200 was set in the fifth station, each as a second toner. A left-right inverted image of an image B was output on [Release Support 1].

Subsequently, all stations of the RICOH Pro C5300S (manufactured by Ricoh) were replaced with developing units modified to use [Developer 3] including [Toner 3]. A full solid image of [Toner 3] was then output onto the left-right inverted image of the image B that had been output on [Release Support 1], thereby producing a transfer sheet. The thickness of the [Toner 3] solid image layer at this time was 100 μm.

As the transfer medium, a white T-shirt (manufactured by United Athle, 4.7-ounce, dry silky touch T-shirt) was overlaid with the surface of the [Toner 3] solid image layer on the transfer sheet, set in a heat press machine (manufactured by Piotec Co., Ltd., Model HTP234PS1), and subjected to heat and pressure at a temperature of 130° C. for 20 seconds under a pressure of 300 g/cm². Thereafter, while still warm, [Release support 1] was peeled off to obtain [Evaluation image 5].

### <Production of Evaluation Image 6>

[Evaluation image 6] was produced in the same manner as [Evaluation image 5], except that [Release support 1] was cooled to room temperature before peeling in the production of [Evaluation image 5].

### Examples 2 to 7 and Comparative Examples 1 to 3

[Evaluation images 1 to 6] were obtained in the same manner as in Example 1, except that the release supports listed in Table 2 were used. However, in the production of all evaluation images in Comparative examples 2 and 3, offset occurred when outputting the left-right inverted image using the second toner onto the release support, making it impossible to print. Further, in the production of all evaluation images in Comparative example 1, release failure of the release support occurred during transfer to the transfer medium, and the release support broke in some places, making it impossible to obtain an evaluation image.

TABLE 2

| | | Transfer sheet | Thermal |
|---|---|---|---|
| | Release support | fixability | transferability |
| Example 1 | Release support 1 | Good | Good |
| Example 2 | Release support 2 | Good | Good |
| Example 3 | Release support 3 | Good | Good |
| Example 4 | Release support 4 | Good | Good |
| Example 5 | Release support 5 | Good | Good |
| Example 6 | Release support 6 | Good | Good |
| Example 7 | Release support 7 | Good | Good |
| Comparative | Release support 8 | Good | Poor |
| example 1 | | | |
| Comparative | Release support 9 | Poor | — |
| example 2 | | | |
| Comparative | Release support 10 | Poor | — |
| example 3 | | | |

### (Evaluation of Transfer Sheet Fixability)

In the production of [Evaluation images 1 to 6], the left-right inverted image was printed on the release support. If no offset occurred in the production of any of the evaluation images, and the images could be printed without any problem, such images were evaluated as “Good”. If the images could not be printed due to offset were evaluated as “Poor”.

### (Evaluation of Thermal Transferability)

In the production of [Evaluation images 1 to 6], the image was transferred to the transfer medium. If there was no release failure of the release support in the production of any of the evaluation images, and the transfer could be performed without any problem, such images were evaluated as “Good”. If there was release failure of the release support, and the release support broke in some places, making it impossible to obtain an evaluation image, such images were evaluated as “Poor”. Note that Comparative examples 2 and 3, in which the left-right inverted image could not be printed, were indicated as “-”.

### (Transfer Image Glossiness Measurement)

In Examples 1 to 7, the glossiness of [Evaluation images 1 to 6] was measured and the results are presented in Table 3.

TABLE 3

| | Transfer image glossiness | | | | | |
|---|---|---|---|---|---|---|
| | Evaluation | Evaluation | Evaluation | Evaluation | Evaluation | Evaluation |
| | image 1 | image 2 | image 3 | image 4 | image 5 | image 6 |
| Example 1 | 18 | 26 | 16 | 24 | 20 | 26 |
| Example 2 | 18 | 25 | 16 | 22 | 20 | 26 |
| Example 3 | 6 | 3 | 5 | 3 | 7 | 6 |
| Example 4 | 5 | 2 | 4 | 2 | 6 | 6 |
| Example 5 | 16 | 25 | 15 | 22 | 18 | 26 |
| Example 6 | 10 | 12 | 9 | 12 | 12 | 14 |
| Example 7 | 6 | 4 | 6 | 4 | 6 | 6 |

Further, the obtained images were subjected to sensory evaluation by 20 men and women aged 25 to 63. For the color images of evaluation images 1 to 4, 18 out of 20 subjects judged that images with a glossiness of less than 10 were preferable in terms of visibility and texture. For the metallic images of evaluation images 5 and 6, 16 out of 20 subjects judged that images with a glossiness of 18 or more were preferable in terms of brilliance and texture.

Note that, for example, aspects of the present disclosure are as follows.

### <Aspect 1>

A transfer sheet including a release support, a first toner, and a second toner, in which: the second toner and the first toner are layered in this order on the surface of the release support; the peeling force of the surface of the release support is 250 mN/25 mm or more and 2000 mN/25 mm or less; the first toner includes a binder resin including a polyurethane resin, and a release agent; the content of the polyurethane resin is 50% by mass or more relative to the entire first toner; a sea-island structure is observed in an SEM image of the cross section of the first toner; the glass transition temperature Tg of the first toner is lower than 0° C.; and the second toner is a color toner including a binder resin, a colorant, and a release agent.

### <Aspect 2>

The transfer sheet according to the <Aspect 1>, in which a substrate of the release support is paper having a basis weight of 70 g/m² or more and 150 g/m² or less.

### <Aspect 3>

The transfer sheet according to the <Aspect 1> or <Aspect 2>, in which a substrate of the release support is glassine paper.

### <Aspect 4>

The transfer sheet according to any one of the <Aspect 1> to <Aspect 3>, in which the peeling force of the surface of the release support is 250 mN/25 mm or more and less than 500 mN/25 mm.

### <Aspect 5>

The transfer sheet according to any one of the <Aspect 1> to <Aspect 3>, in which the peeling force of the surface of the release support is 1000 mN/25 mm or more and 2000 mN/25 mm or less.

### <Aspect 6>

An image forming method including transferring an image onto a transfer medium by thermal pressure transfer using the transfer sheet according to any one of the <Aspect 1> to <Aspect 5>.

The transfer sheets described in the <Aspect 1> to <Aspect 5> and the image forming method described in the <Aspect 6> can solve the above-mentioned various conventional problems and achieve the above-mentioned object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A transfer sheet comprising:
a release support having a surface having a peeling force of 250 mN/25 mm or more and 2000 mN/25 mm or less;
a first toner:
including a release agent and a binder resin, the binder resin including a polyurethane resin accounting for 50% by mass or more of the first toner;
having a sea-island structure in a scanning electron microscopic image of a cross section of the first toner; and
having a glass transition temperature of lower than 0° C.; and
a second toner being a color toner including a binder resin, a colorant, and a release agent,
wherein the second toner is layered over the surface of the release support, and the first toner is layered over the second toner.

2. The transfer sheet according to claim 1, wherein the release support includes a substrate comprising paper having a basis weight of 70 g/m² or more and 150 g/m² or less.

3. The transfer sheet according to claim 1, wherein the release support includes a substrate comprising glassine paper.

4. The transfer sheet according to claim 1, wherein the surface of the release support has a peeling force of 250 mN/25 mm or more and less than 500 mN/25 mm.

5. The transfer sheet according to claim 1, wherein the surface of the release support has a peeling force of 1000 mN/25 mm or more and 2000 mN/25 mm or less.

6. An image forming method comprising:
transferring an image onto a transfer medium by thermal pressure transfer using the transfer sheet according to claim 1.
